(19) United States
(12) Patent Application Publication
(10) Pub. No.: US 2024/0140856 A1
(43) Pub. Date: May 2, 2024

(54) GLASS COMPOSITIONS AND GLASS-CERAMIC ARTICLES FORMED THEREFROM HAVING IMPROVED MECHANICAL DURABILITY

(71) Applicant: CORNING INCORPORATED, Corning, NY (US)

(72) Inventors: Qiang Fu, Painted Post, NY (US); Charlene Marie Smith, Corning, NY (US); Alana Marie Whittier, Painted Post, NY (US); Taylor Marie Wilkinson, Painted Post, NY (US)

(21) Appl. No.: 18/380,710

(22) Filed: Oct. 17, 2023

Related U.S. Application Data
(60) Provisional application No. 63/420,952, filed on Oct. 31, 2022.

(51) Int. Cl. C03C 10/00; C03B 32/02; C03C 21/00

(52) U.S. Cl. CPC C03C 10/0027; C03B 32/02; C03C 10/0009; C03C 21/002; C03C 2204/00

(57) ABSTRACT

A glass-ceramic article includes a crystalline phase, a residual glass phase, greater than or equal to 55 mol % and less than or equal to 80 mol % SiO₂, greater than or equal to 1 mol % and less than or equal to 8 mol % Al₂O₃, greater than or equal to 13 mol % and less than or equal to 35 mol % Li₂O, greater than or equal to 0.05 mol % and less than or equal to 5 mol % Na₂O, greater than or equal to 0.05 mol % and less than or equal to 3 mol % K₂O, greater than or equal to 0.2 mol % and less than or equal to 2 mol % P₂O₅, and greater than or equal to 1.5 mol % and less than or equal to 10 mol % ZrO₂, wherein the crystalline phase comprises a lithium disilicate sub-phase.

This application claims the benefit of priority under 35 U.S.C. § 119 of U.S. Provisional Application Ser. No. 63/420,952 filed on Oct. 31, 2022, the content of which is relied upon and incorporated herein by reference in its entirety.

### FIELD

The present specification relates to glass compositions and glass-ceramic articles and, in particular, to glass compositions and ion exchangeable glass-ceramic articles formed therefrom.

### TECHNICAL BACKGROUND

Glass articles, such as cover glasses, glass backplanes, housings, and the like, are employed in both consumer and commercial electronic devices, such as smart phones, tablets, portable media players, personal computers, and cameras. The mobile nature of these portable devices makes the devices and the glass articles included therein particularly vulnerable to accidental drops on hard surfaces, such as the ground. Moreover, glass articles, such as cover glasses, may include “touch” functionality which necessitates that the glass article be contacted by various objects including a user's fingers and/or stylus devices. Accordingly, the glass articles must be sufficiently robust to endure accidental dropping and regular contact without damage, such as scratching. Indeed, scratches introduced into the surface of the glass article may reduce the strength of the glass article as the scratches may serve as initiation points for cracks, leading to optical interference and catastrophic failure of the glass.

Moreover, the optical characteristics of the glass article, such as the haze of the glass article, may be an important consideration when the glass article is incorporated as a cover glass in a portable electronic device.

Accordingly, a need exists for alternative materials which have improved mechanical properties relative to glass while also having optical characteristics similar to glass.

### SUMMARY

According to a first aspect A1, a glass-ceramic article may include: a crystalline phase; a residual glass phase; greater than or equal to 55 mol % and less than or equal to 80 mol % SiO₂; greater than or equal to 1 mol % and less than or equal to 8 mol % Al₂O₃; greater than or equal to 13 mol % and less than or equal to 35 mol % Li₂O; greater than or equal to 0.05 mol % and less than or equal to 5 mol % Na₂O; greater than or equal to 0.05 mol % and less than or equal to 3 mol % K₂O; greater than or equal to 0.2 mol % and less than or equal to 2 mol % P₂O₅; and greater than or equal to 1.5 mol % and less than or equal to 10 mol % ZrO₂, wherein the crystalline phase comprises a lithium disilicate sub-phase.

A second aspect A2 includes the glass-ceramic article according to the first aspect A1, wherein the lithium disilicate sub-phase is present in a greater amount, based on a total weight of the crystalline phase, than any other sub-phase in the crystalline phase.

A third aspect A3 includes the glass-ceramic article according to the first aspect A1 or the second aspect A2, wherein the glass-ceramic article has a surface concentration of K₂O greater than or equal to 1 mol %.

A fourth aspect A4 includes the glass-ceramic article according to any one of the first through third aspects A1-A3, wherein the glass-ceramic article has a haze less than or equal to 0.5, as measured at an article thickness of 0.6 mm.

A fifth aspect A5 includes the glass-ceramic article according to any one of the first through fourth aspects A1-A4, wherein the glass-ceramic article has a widest width of lateral cracking less than or equal to 125 μm when subjected to scratch testing to initiate a scratch with a 10 μm/90 degree angle conospherical tip, a scratch speed of 24 mm/min, and a constant load of 0.5 N.

A sixth aspect A6 includes the glass-ceramic article according to any one of the first through fifth aspects A1-A5, wherein the glass-ceramic article has a mean width of lateral cracking less than or equal to 100 μm when subjected to scratch testing to initiate a scratch with a 10 μm/90 degree angle conospherical tip, a scratch speed of 24 mm/min, and a constant load of 0.5 N.

A seventh aspect A7 includes the glass-ceramic article according to any one of the first through sixth aspects A1-A6, wherein Na₂O+K₂O is greater than or equal to 0.1 mol % to less than or equal to 8 mol %.

An eighth aspect A8 includes the glass-ceramic article according to any one of the first through seventh aspects A1-A7, wherein the glass-ceramic article comprises greater than or equal to 0.1 mol % and less than or equal to 4.5 mol % Na₂O.

A ninth aspect A9 includes the glass-ceramic article according to any one of the first through eighth aspects A1-A8, wherein the glass-ceramic article comprises greater than or equal to 0.1 mol % and less than or equal to 2.5 mol % K₂O.

A tenth aspect A10 includes the glass-ceramic article according to any one of the first through ninth aspects A1-A9, wherein the glass-ceramic article comprises greater than or equal to 2 mol % and less than or equal to 9 mol % ZrO₂.

An eleventh aspect A11 includes the glass-ceramic article according to any one of the first through tenth aspects A1-A10, wherein the glass-ceramic article comprises greater than or equal to 14 mol % and less than or equal to 33 mol % Li₂O.

A twelfth aspect A12 includes the glass-ceramic article according to any one of the first through eleventh aspects A1-A11, wherein the glass-ceramic article comprises greater than or equal to 1.25 mol % and less than or equal to 6 mol % Al₂O₃.

A thirteenth aspect A13 includes the glass-ceramic article according to any one of the first through twelfth aspects A1-A12, wherein the glass-ceramic article comprises greater than or equal to 0.4 mol % and less than or equal to 1.75 mol % P₂O₅.

A fourteenth aspect A14 includes the glass-ceramic article according to any one of the first through thirteenth aspects A1-A13, wherein the crystalline phase of the glass-ceramic article comprises a lithium metasilicate sub-phase, a lithium phosphate sub-phase, a petalite sub-phase, a cristobalite sub-phase, or combinations thereof.

A fifteenth aspect A15 includes the glass-ceramic article according to any one of the first through fourteenth aspects A1-A14, wherein the glass-ceramic article comprises greater than or equal to 35 wt % and less than or equal to 80 wt % of the crystalline phase, based on a total weight of the glass-ceramic article, with a remainder of the glass-ceramic article comprising the residual glass phase.

A sixteenth aspect A16 includes the glass-ceramic article according to any one of the first through fifteenth aspects A1-A15, wherein the glass-ceramic article has a peak surface compressive stress greater than or equal to 500 MPa.

A seventeenth aspect A17 includes the glass-ceramic article according to any one of the first through sixteenth aspects A1-A16, wherein the glass-ceramic article has a depth of layer greater than or equal to 2 μm.

An eighteenth aspect A18 includes the glass-ceramic article according to any one of the first through seventeenth aspects A1-A17, wherein the glass-ceramic article has a maximum central tension greater than or equal to 65 MPa.

A nineteenth aspect A19 includes the glass-ceramic article according to any one of the first through eighteenth aspects A1-A18, wherein the glass ceramic article has a thickness “t” and a depth of compression greater than or equal to 0.05t.

A twentieth aspect A20 includes the glass-ceramic article according to any one of the first through nineteenth aspects A1-A19, wherein the glass-ceramic article has an elastic modulus greater than or equal to 95 GPa.

A twenty-first aspect A21 includes the glass-ceramic article according to any one of the first through twentieth aspects A1-A20, wherein the glass-ceramic article has a K_{Ic} fracture toughness as measured by a chevron notched short bar method is greater than or equal to 1.1 MPa·m^{1/2}.

According to a twenty-second aspect A22, a glass composition may include: greater than or equal to 55 mol % and less than or equal to 80 mol % SiO₂; greater than or equal to 1 mol % and less than or equal to 8 mol % Al₂O₃; greater than or equal to 13 mol % and less than or equal to 35 mol % Li₂O; greater than or equal to 0.01 mol % and less than or equal to 5 mol % Na₂O; greater than or equal to 0.10 mol % and less than or equal to 3 mol % K₂O; greater than or equal to 0.2 mol % and less than or equal to 2 mol % P₂O₅; and greater than or equal to 1.5 mol % and less than or equal to 10 mol % ZrO₂.

A twenty-third aspect A23 includes the glass composition according to the twenty-second aspect A22, wherein Na₂O/(Na₂O+K₂O) is greater than or equal to 0.02 and less than or equal to 0.99.

A twenty-fourth aspect A24 includes the glass composition according to the twenty-second aspect A22 or the twenty-third aspect A23, wherein Na₂O+K₂O is greater than or equal to 0.2 mol % to less than or equal to 8 mol %.

A twenty-fifth aspect A25 includes the glass composition according to the twenty-second through twenty-fourth aspects A22-A24, wherein the glass composition comprises greater than or equal to 0.10 mol % and less than or equal to 4.5 mol % Na₂O.

A twenty-sixth aspect A26 includes the glass composition according to any one of the twenty-second through twenty-fifth aspects A22-A25, wherein the glass composition comprises greater than or equal to 0.10 mol % and less than or equal to 2.5 mol % K₂O.

A twenty-seventh aspect A27 includes the glass composition according to any one of the twenty-second through twenty-sixth aspects A22-A26, wherein the glass composition comprises greater than or equal to 2 mol % and less than or equal to 9 mol % ZrO₂.

A twenty-eighth aspect A28 includes the glass composition according to any one of the twenty-second through twenty-seventh aspects A22-A27, wherein the glass composition comprises greater than or equal to 14 mol % and less than or equal to 33 mol % Li₂O.

A twenty-ninth aspect A29 includes the glass composition according to any one of the twenty-second through twenty-eighth aspects A22-A28, wherein the glass composition comprises greater than or equal to 1.25 mol % and less than or equal to 6 mol % Al₂O₃.

A thirtieth aspect A30 includes the glass composition according to any one of the twenty-second through twenty-ninth aspects A22-A29, wherein the glass composition comprises greater than or equal to 0.4 mol % and less than or equal to 1.75 mol % P₂O₅.

A thirty-first aspect A31 includes the glass composition according to any one of the twenty-second through thirtieth aspects A22-A30, wherein the glass composition has a liquidus temperature greater than or equal to 800° C. and less than or equal to 1400° C.

A thirty-second aspect A32 includes the glass composition according to any one of the twenty-second through thirty-first aspects A22-A31, wherein the glass composition has a liquidus viscosity greater than or equal to 0.25 kilopoise and less than or equal to 5 kilopoise.

According to a thirty-third aspect A33, a method of forming a glass-ceramic article may include: heating a precursor glass article in an oven at a rate greater than or equal to 1° C./min and less than or equal to 10° C./min to a nucleation temperature, wherein the precursor glass article comprises a glass composition comprising: greater than or equal to 55 mol % and less than or equal to 80 mol % SiO₂; greater than or equal to 1 mol % and less than or equal to 8 mol % Al₂O₃; greater than or equal to 13 mol % and less than or equal to 35 mol % Li₂O; greater than or equal to 0.10 mol % and less than or equal to 5 mol % Na₂O; greater than or equal to 0.10 mol % and less than or equal to 3 mol % K₂O; greater than or equal to 0.2 mol % and less than or equal to 2 mol % P₂O₅; and greater than or equal to 1.5 mol % and less than or equal to 10 mol % ZrO₂; maintaining the precursor glass article at the nucleation temperature in the oven for a nucleation time greater than or equal to 0.1 hour and less than or equal to 8 hours to produce a nucleated crystallizable glass article; heating the nucleated crystallizable glass article in the oven at a rate greater than or equal to 1° C./min and less than or equal to 10° C./min to a crystallization temperature; maintaining the nucleated crystallizable glass article at the crystallization temperature in the oven for a crystallization time greater than or equal to 0.25 hour and less than or equal to 4 hours to produce the glass-ceramic article, wherein the glass-ceramic article comprises a crystalline phase and a residual glass phase; and cooling the glass-ceramic article to room temperature.

A thirty-fourth aspect A34 includes the method according to the thirty-third aspect A33, wherein the crystalline phase comprises a lithium disilicate sub-phase, the lithium disilicate sub-phase being present in a greater amount, based on a total weight of the crystalline phase, than any other sub-phase in the crystalline phase.

A thirty-fifth aspect A35 includes the method according to the thirty-third aspect A33 or the thirty-fourth aspect A34, wherein the glass-ceramic article has a haze less than or equal to 0.5, as measured at an article thickness of 0.6 mm.

A thirty-sixth aspect A36 includes the method according to the thirty-third through thirty-fifth aspects A33-A35, wherein the glass-ceramic article has an elastic modulus greater than or equal to 95 GPa.

A thirty-seventh aspect 37 includes the method according to any one of the thirty-third through thirty-sixth aspects A33-A36, wherein the glass-ceramic article has a Kip fracture toughness as measured by a chevron notched short bar method is greater than or equal to 1.1 MPa·m^{1/2}.

A thirty-eighth aspect 38 includes the method according to any one of the thirty-third through thirty-seventh aspects A33-A37, further comprising strengthening the glass-ceramic article in a first ion exchange bath at a first bath temperature greater than or equal to 350° C. to less than or equal to 550° C. for an ion exchange time period greater than or equal to 2 hours to less than or equal to 12 hours to form an ion exchanged glass-ceramic article.

A thirty-ninth aspect 39 includes the method according to the thirty-eighth aspect A38, further comprising strengthening the glass-ceramic article in a second ion exchange bath at a second bath temperature greater than or equal to 350° C. to less than or equal to 550° C. for a second ion exchange time period greater than or equal to 0.25 hour to less than or equal to 4 hours.

A fortieth aspect A40 includes the method according to the thirty-eighth aspect A38 or the thirty-ninth aspect A39, wherein the first ion exchange bath comprises sodium ions, potassium ions, lithium ions, or combinations thereof.

A forty-first aspect A41 includes the method according to any one of the thirty-eighth through fortieth aspects A38-A40, wherein the ion exchanged glass-ceramic article has a surface concentration of K₂O greater than or equal to 1 mol %.

A forty-second aspect A42 includes the method according to any one of the thirty-eighth through forty-first aspects A38-A41, wherein the ion exchanged glass-ceramic article has a peak surface compressive stress greater than or equal to 500 MPa.

A forty-third aspect A43 includes the method according to any one of the thirty-eighth through forty-second aspects A38-A42, wherein the ion exchanged glass-ceramic article has a widest width of lateral cracking less than or equal to 125 μm when subjected to scratch testing to initiate a scratch with a 10 μm/90 degree angle conospherical tip, a scratch speed of 24 mm/min, and a constant load of 0.5 N.

A forty-fourth aspect A44 includes the method according to any one of the thirty-eighth through forty-third aspects A38-A43, wherein the ion exchanged glass-ceramic article has a mean width of lateral cracking less than or equal to 100 μm when subjected to scratch testing to initiate a scratch with a 10 μm/90 degree angle conospherical tip, a scratch speed of 24 mm/min, and a constant load of 0.5 N.

A forty-fifth aspect A45 includes the method according to any one of the thirty-eighth through forty-fourth aspects A38-A44, wherein the ion exchanged glass-ceramic article has a depth of layer greater than or equal to 2 μm.

A forty-sixth aspect A46 includes the method according to any one of the thirty-eighth through forty-fifth aspects A38-A45, wherein the ion exchanged glass-ceramic article has a maximum central tension greater than or equal to 65 MPa.

A forty-seventh aspect A47 includes the method according to any one of the thirty-eighth through forty-sixth aspects A38-A46, wherein the ion exchanged glass ceramic article has a thickness “t” and a depth of compression greater than or equal to 0.05t.

A forty-eighth aspect A48 includes a consumer electronic device, comprising: a housing having a front surface, a back surface, and side surfaces; electrical components provided at least partially within the housing, the electrical components including at least a controller, a memory, and a display, the display being provided at or adjacent the front surface of the housing; and the glass-ceramic article of any one of the first through twenty-first aspects A1-A21 at least one of disposed over the display and forming a portion of the housing.

Additional features and advantages of the glass compositions and the resultant glass-ceramic articles described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 is a plan view of an electronic device incorporating any of the glass-ceramic articles according to one or more embodiments described herein;

FIG. 2 is a perspective view of the electronic device of FIG. 1;

FIG. 3 is a plot of oxide concentration (x-axis: depth (μm); y-axis: oxide concentration (mol %)) of an ion exchanged glass-ceramic article made from a glass composition, according to one or more embodiments described herein;

FIG. 4 are micrographs of ion exchanged glass-ceramic articles subjected to scratch testing using a constant load of 0.25 N, according to one or more embodiments described herein;

FIG. 5 are micrographs of ion exchanged glass-ceramic articles subjected to scratch testing using a constant load of 0.5 N, according to one or more embodiments described herein; and

FIG. 6 is a plot of load at failure (in kilogram-force (kgf)) of ion exchanged example and comparative articles subjected to a ring-on-ring test, according to one or more embodiments described herein.

### DETAILED DESCRIPTION

Reference will now be made in detail to various embodiments of glass compositions and glass-ceramic articles having improved mechanical durability formed therefrom. According to embodiments, a glass-ceramic article may comprise a crystalline phase, a residual glass phase, greater than or equal to 55 mol % and less than or equal to 80 mol % SiO₂, greater than or equal to 1 mol % and less than or equal to 8 mol % Al₂O₃, greater than or equal to 13 mol % and less than or equal to 35 mol % Li₂O, greater than or equal to 0.05 mol % and less than or equal to 5 mol % Na₂O, greater than or equal to 0.05 mol % and less than or equal to 3 mol % K₂O, greater than or equal to 0.2 mol % and less than or equal to 2 mol % P₂O₅; and greater than or equal to 1.5 mol % and less than or equal to 10 mol % ZrO₂. The crystalline phase may comprise a lithium disilicate sub-phase. Various embodiments of glass compositions and methods of forming ion exchangeable glass-ceramic articles therefrom will be referred to herein with specific reference to the appended drawings.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply ab solute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

The term “substantially free,” when used to describe the concentration and/or absence of a particular constituent component in a glass composition and the resultant glass-ceramic article, means that the constituent component is not intentionally added to the glass composition and the resultant glass-ceramic article. However, the glass composition and the resultant glass-ceramic article may contain traces of the constituent component as a contaminant or tramp in amounts of less than 0.05 weight percent (wt %). As noted herein, the remainder of the application specifies the concentrations of constituent component in mol %. The contaminant or tramp amounts of the constituent components are listed in wt % for manufacturing purposes and one skilled in the art would understand the contaminant and tramp amounts being listed in wt %.

The terms “0 mol %” and “free,” when used to describe the concentration and/or absence of a particular constituent component in a glass composition and the resultant glass-ceramic article, means that the constituent component is not present in glass composition and the resultant glass-ceramic article.

In embodiments of the glass compositions and the resultant glass-ceramic articles described herein, the concentrations of constituent components (e.g., SiO₂, Al₂O₃, and the like) are specified in mole percent (mol %) on an oxide basis, unless otherwise specified.

The term “liquidus temperature,” as used herein, refers to the temperature at which the glass composition begins to devitrify as determined with the gradient furnace method according to ASTM C829-81.

The term “liquidus viscosity,” as used herein, refers to the viscosity of the glass composition at the onset of devitrification (i.e., at the liquidus temperature as determined with the gradient furnace method according to ASTM C829-81).

Fracture toughness (K_{Ic}) represents the ability of a glass composition to resist fracture. Fracture toughness is measured on a non-strengthened glass-ceramic article, such as measuring the K_{Ic} value prior to ion exchange treatment of the glass-ceramic article, thereby representing a feature of a glass-ceramic article prior to ion exchange. The fracture toughness test methods described herein are not suitable for glasses that have been exposed to ion exchange treatment. But, fracture toughness measurements performed as described herein on the same glass-ceramic article prior to ion exchange treatment correlate to fracture toughness after ion exchange treatment, and are accordingly used as such. The chevron notched short bar (CNSB) method utilized to measure the K_{Ic} value is disclosed in Reddy, K. P. R. et al, “Fracture Toughness Measurement of Glass and Ceramic Materials Using Chevron-Notched Specimens,” J. Am. Ceram. Soc., 71 [6], C-310-C-313 (1988) except that Y*m is calculated using equation 5 of Bubsey, R. T. et al., “Closed-Form Expressions for Crack-Mouth Displacement and Stress Intensity Factors for Chevron-Notched Short Bar and Short Rod Specimens Based on Experimental Compliance Measurements,” NASA Technical Memorandum 83796, pp. 1-30 (October 1992). Unless otherwise specified, all fracture toughness values were measured by chevron notched short bar (CNSB) method.

The elastic modulus (also referred to as Young's modulus) of the glass-ceramic article, as described herein, is provided in units of gigapascals (GPa) and is measured in accordance with ASTM C623. Elastic modulus is measured on a non-strengthened glass-ceramic article, such as measuring the elastic modulus value prior to ion exchange treatment of the glass-ceramic article, thereby representing a feature of a glass-ceramic article prior to ion exchange.

The shear modulus of the glass-ceramic article, as described herein, is provided in units of gigapascals (GPa) and is measured in accordance with ASTM C623.

Poisson's ratio, as described herein is measured in accordance with ASTM C623.

The term “haze,” as used herein, is measured via BYK Haze-Gard according to ASTM D1003.

The term “transparent,” when used to describe a glass-ceramic article formed of a glass composition described herein, means that the glass-ceramic article has a haze less than or equal to 0.5, as measured at an article thickness of 0.6 mm.

X-ray diffraction (XRD) spectrum, as described herein, is measured with a D8 ENDEAVOR X-ray Diffraction system with a LYNXEYE XE-T detector manufactured by Bruker Corporation (Billerica, MA).

Surface compressive stress is measured with a surface stress meter (FSM) such as commercially available instruments such as the FSM-6000, manufactured by Orihara Industrial Co., Ltd. (Japan). Surface stress measurements rely upon the measurement of the stress optical coefficient (SOC), which is related to the birefringence of the glass-ceramic article. SOC, in turn, is measured according to Procedure C (Glass Disc Method) described in ASTM standard C770-16, entitled “Standard Test Method for Measurement of Glass Stress-Optical Coefficient,” the contents of which are incorporated herein by reference in their entirety. The values reported for surface compressive stress (CS) herein refer to the peak surface compressive stress, unless otherwise indicated. Depth of compression (DOC) is measured with the FSM in conjunction with a scatter light polariscope (SCALP) technique known in the art. FSM measures the depth of compression for potassium ion exchange and SCALP measures the depth of compression for sodium ion exchange. The maximum central tension (CT) values are measured using a SCALP technique known in the art. The values reported for central tension (CT) herein refer to the maximum central tension, unless otherwise indicated.

According to the convention normally used in the art, compression or compressive stress (CS) is expressed as a negative (i.e., <0) stress and tension or tensile stress is expressed as a positive (i.e., >0) stress. Throughout this description, however, CS is expressed as a positive or absolute value (i.e., as recited herein, CS=|CS|).

The term “surface concentration,” as described herein, refers to a concentration of the component in the top three (3) μm of the glass-ceramic article, as measured from a top surface of the glass-ceramic article into a thickness of the glass-ceramic article, by using electron probe microanalysis (EPMA).

The terms “depth of compression” and “DOC” refer to the position in the glass-ceramic article where compressive stress transitions to tensile stress. At the DOC, the stress crosses from a compressive stress to a tensile stress and thus exhibits a stress value of zero. Depth of compression may be measured using a Scattered Light Polariscope (SCALP), such as a SCALP-05 portable scattered light polariscope. As used herein, “depth of layer” (DOL) refers to the depth within a multi-phase glass at which an ion of metal oxide diffuses into the multi-phase glass where the concentration of the ion reaches a minimum value. DOL may be measured using electron probe microanalysis (EPMA). Unless otherwise indicated, DOL indicates the depth of potassium ion diffusion.

The term “glass composition,” as used herein, refers to a glass composition, which, upon heat treatment, may form a glass article or a glass-ceramic article.

The term “precursor glass article,” as used herein, refers to a glass article containing one or more nucleating agents which, upon heat treatment, causes the nucleation of a crystalline phase in the glass.

The term “glass-ceramic article,” as used herein, refers to an article formed from heat treating a precursor glass article formed from a glass composition to induce nucleation and subsequent precipitation and growth of the desired crystalline phase(s). In embodiments, the glass-ceramic articles have about 40 wt % to about 99 wt % crystallinity.

For ease of reading, the term “glass composition” is referred to throughout the Detailed Description. However, it should be appreciated that the glass-ceramic articles described herein are produced by heat treating a precursor glass article formed from the glass composition.

Glass-ceramic articles generally have improved fracture toughness relative to articles formed from glass due to the presence of crystalline grains, which impede crack growth, and the relatively high elastic modulus of the glass-ceramic articles. However, upon insults to the glass-ceramic surface, such as scratching, subsurface damage to glass-ceramic articles may result in material lift up above the glass-ceramic article surface, leading to optical interference fringes as a consequence of an air gap below the lifted surface. Moreover, over time, subsurface damage may evolve further, eventually intersecting the glass-ceramic article surface to form a lateral crack system, which may be highly visible to the user.

Disclosed herein are glass compositions and glass-ceramic articles formed therefrom which mitigate the aforementioned problems. Specifically, the glass compositions described herein comprise relatively high concentrations of Li₂O, Na₂O, K₂O, and ZrO₂ and may be subjected to certain heat treatments to form glass-ceramic articles that may be ion exchanged to achieve a relatively high peak surface compressive stress (e.g., greater than or equal to 500 MPa). While not wishing to be bound by theory, it is believed that a relatively high peak surface compressive stress may help minimize subsurface damage upon scratching, thereby preventing the formation of lateral crack systems and ultimately resulting in lower scratch visibility for the user. The glass-ceramic articles have a relatively high amount of Li₂O and Na₂O present in the residual glass phase. Thus, the residual glass phase may be readily ion exchanged to achieve a relatively high K₂O surface concentration (e.g., greater than or equal to 1 mol %), which results in a relatively high peak surface compressive stress.

The glass compositions and glass-ceramic articles described herein may be described as lithium aluminosilicate glass compositions and glass-ceramic articles and comprise SiO₂, Al₂O₃, and Li₂O. In addition to SiO₂, Al₂O₃, and Li₂O, the glass compositions and glass-ceramic articles described herein further include ZrO₂ and P₂O₅ to achieve crystalline phases, including lithium disilicate. Along with Li₂O, the glass compositions and glass-ceramic articles described herein further include Na₂O and K₂O to ensure ion exchangeability of the resulting glass-ceramic articles.

SiO₂ is the primary glass former in the glass compositions described herein and may function to stabilize the network structure of the glass-ceramic articles. The concentration of SiO₂ in the glass compositions should be sufficiently high (e.g., greater than or equal to 55 mol %) to form a crystalline phase including lithium disilicate when the glass composition is subjected to heat treatment to convert the glass composition to a glass-ceramic article. The concentration of SiO₂ may be limited (e.g., less than or equal to 80 mol %) to control the melting point of the glass composition, as the melting temperature of pure SiO₂ or high SiO₂ glasses is undesirably high. Thus, limiting the concentration of SiO₂ may aid in improving the meltability and the formability of the resulting glass-ceramic article.

Accordingly, in embodiments, the glass composition and the resultant glass-ceramic article may comprise greater than or equal to 55 mol % and less than or equal to 80 mol % SiO₂. In embodiments, the concentration of SiO₂ in the glass composition and the resultant glass-ceramic article may be greater than or equal to 55 mol %, greater than or equal to 57 mol %, greater than or equal to 60 mol %, greater than or equal to 63 mol %, or even greater than or equal to 65 mol %. In embodiments, the concentration of SiO₂ in the glass composition and the resultant glass-ceramic article may be less than or equal to 80 mol %, less than or equal to 77 mol %, less than or equal to 75 mol %, less than or equal to 73 mol %, or even less than or equal to 70 mol %. In embodiments, the concentration of SiO₂ in the glass composition and the resultant glass-ceramic article may be greater than or equal to 55 mol % and less than or equal to 80 mol %, greater than or equal to 55 mol % and less than or equal to 77 mol %, greater than or equal to 55 mol % and less than or equal to 75 mol %, greater than or equal to 55 mol % and less than or equal to 73 mol %, greater than or equal to 55 mol % and less than or equal to 70 mol %, greater than or equal to 57 mol % and less than or equal to 80 mol %, greater than or equal to 57 mol % and less than or equal to 77 mol %, greater than or equal to 57 mol % and less than or equal to 75 mol %, greater than or equal to 57 mol % and less than or equal to 73 mol %, greater than or equal to 57 mol % and less than or equal to 70 mol %, greater than or equal to 60 mol % and less than or equal to 80 mol %, greater than or equal to 60 mol % and less than or equal to 77 mol %, greater than or equal to 60 mol % and less than or equal to 75 mol %, greater than or equal to 60 mol % and less than or equal to 73 mol %, greater than or equal to 60 mol % and less than or equal to 70 mol %, greater than or equal to 63 mol % and less than or equal to 80 mol %, greater than or equal to 63 mol % and less than or equal to 77 mol %, greater than or equal to 63 mol % and less than or equal to 75 mol %, greater than or equal to 63 mol % and less than or equal to 73 mol %, greater than or equal to 63 mol % and less than or equal to 70 mol %, greater than or equal to 65 mol % and less than or equal to 80 mol %, greater than or equal to 65 mol % and less than or equal to 77 mol %, greater than or equal to 65 mol % and less than or equal to 75 mol %, greater than or equal to 65 mol % and less than or equal to 73 mol %, or even greater than or equal to 65 mol % and less than or equal to 70 mol %, or any and all sub-ranges formed from any of these endpoints.

Like SiO₂, Al₂O₃ may also stabilize the glass network and additionally provides improved mechanical properties and chemical durability to the resulting glass-ceramic article. The concentration of Al₂O₃ may also be tailored to the control the viscosity of the glass composition. If the concentration of Al₂O₃ is too high, the viscosity of the melt may increase in an undesirable way. The concentration of Al₂O₃ should be sufficiently low (e.g., less than or equal to 8 mol %) such that the resulting glass-ceramic article has lithium disilicate present in a greater amount than any other sub-phase in the crystalline phase and has the desired fracture toughness (e.g., greater than or equal to 1.1 MPa·m^{1/2}). If the concentration of Al₂O₃ is too high (e.g., greater than 8 mol %), the fraction of lithium disilicate nanocrystals may decrease.

In embodiments, the glass composition and the resultant glass-ceramic article may comprise greater than or equal to 1 mol % and less than or equal to 8 mol % Al₂O₃. In embodiments, the glass composition and the resultant glass-ceramic article may comprise greater than or equal to 1.25 mol % and less than or equal to 6 mol % Al₂O₃. In embodiments, the concentration of Al₂O₃ in the glass composition and the resultant glass-ceramic article may be greater than or equal to 1 mol %, greater than or equal to 1.25 mol %, or even greater than or equal to 1.5 mol %. In embodiments, the concentration of Al₂O₃ in the glass composition and the resultant glass-ceramic article may be less than or equal to 8 mol %, less than or equal to 6 mol %, or even less than or equal to 4 mol %. In embodiments, the concentration of Al₂O₃ in the glass composition and the resultant glass-ceramic article may be greater than or equal to 1 mol % and less than or equal to 8 mol %, greater than or equal to 1 mol % and less than or equal to 6 mol %, greater than or equal to 1 mol % and less than or equal to 4 mol %, greater than or equal to 1.25 mol % and less than or equal to 8 mol %, greater than or equal to 1.25 mol % and less than or equal to 6 mol %, greater than or equal to 1.25 mol % and less than or equal to 4 mol %, greater than or equal to 1.5 mol % and less than or equal to 8 mol %, greater than or equal to 1.5 mol % and less than or equal to 6 mol %, or even greater than or equal to 1.5 mol % and less than or equal to 4 mol %, or any and all sub-ranges formed from any of these endpoints.

Li₂O aids in the ion exchangeability of the resulting glass-ceramic article. Li₂O reduces the softening point of the glass composition thereby increasing the formability of the resulting glass-ceramic article. Li₂O is a constituent in lithium disilicate and may be included in the glass compositions in such a concentration (e.g., greater than or equal to 13 mol %) to achieve this phase. The concentration of Li₂O should be sufficiently high (e.g., greater than or equal to 13 mol %) to produce the Li-containing crystalline phase(s) and to ensure ion exchangeability of the resulting glass-ceramic article.

Accordingly, in embodiments, the glass composition and the resultant glass-ceramic article may comprise greater than or equal to 13 mol % and less than or equal to 35 mol % Li₂O. In embodiments, the glass composition and the resultant glass-ceramic article may comprise greater than or equal to 14 mol % and less than or equal to 33 mol % Li₂O. In embodiments, the concentration of Li₂O in the glass composition and the resultant glass-ceramic article may be greater than or equal to 13 mol %, greater than or equal to 14 mol %, greater than or equal to 15 mol %, greater than or equal to 16 mol %, greater than or equal to 17 mol %, greater than or equal to 18 mol %, greater than or equal to 19 mol %, or even greater than or equal to 20 mol %. In embodiments, the concentration of Li₂O in the glass composition and the resultant glass-ceramic article may be less than or equal to 35 mol %, less than or equal to 33 mol %, less than or equal to 30 mol %, less than or equal to 27 mol %, or even less than or equal to 25 mol %. In embodiments, the concentration of Li₂O in the glass composition and the resultant glass-ceramic article may be greater than or equal to 13 mol % and less than or equal to 35 mol %, greater than or equal to 13 mol % and less than or equal to 33 mol %, greater than or equal to 13 mol % and less than or equal to 30 mol %, greater than or equal to 13 mol % and less than or equal to 27 mol %, greater than or equal to 13 mol % and less than or equal to 25 mol %, greater than or equal to 14 mol % and less than or equal to 35 mol %, greater than or equal to 14 mol % and less than or equal to 33 mol %, greater than or equal to 14 mol % and less than or equal to 30 mol %, greater than or equal to 14 mol % and less than or equal to 27 mol %, greater than or equal to 14 mol % and less than or equal to 25 mol %, greater than or equal to 15 mol % and less than or equal to 35 mol %, greater than or equal to 15 mol % and less than or equal to 33 mol %, greater than or equal to 15 mol % and less than or equal to 30 mol %, greater than or equal to 15 mol % and less than or equal to 27 mol %, greater than or equal to 15 mol % and less than or equal to 25 mol %, greater than or equal to 16 mol % and less than or equal to 35 mol %, greater than or equal to 16 mol % and less than or equal to 33 mol %, greater than or equal to 16 mol % and less than or equal to 30 mol %, greater than or equal to 16 mol % and less than or equal to 27 mol %, greater than or equal to 16 mol % and less than or equal to 25 mol %, greater than or equal to 17 mol % and less than or equal to 35 mol %, greater than or equal to 17 mol % and less than or equal to 33 mol %, greater than or equal to 17 mol % and less than or equal to 30 mol %, greater than or equal to 17 mol % and less than or equal to 27 mol %, greater than or equal to 17 mol % and less than or equal to 25 mol %, greater than or equal to 18 mol % and less than or equal to 35 mol %, greater than or equal to 18 mol % and less than or equal to 33 mol %, greater than or equal to 18 mol % and less than or equal to 30 mol %, greater than or equal to 18 mol % and less than or equal to 27 mol %, greater than or equal to 18 mol % and less than or equal to 25 mol %, greater than or equal to 19 mol % and less than or equal to 35 mol %, greater than or equal to 19 mol % and less than or equal to 33 mol %, greater than or equal to 19 mol % and less than or equal to 30 mol %, greater than or equal to 19 mol % and less than or equal to 27 mol %, greater than or equal to 19 mol % and less than or equal to 25 mol %, greater than or equal to 20 mol % and less than or equal to 35 mol %, greater than or equal to 20 mol % and less than or equal to 33 mol %, greater than or equal to 20 mol % and less than or equal to 30 mol %, greater than or equal to 20 mol % and less than or equal to 27 mol %, or even greater than or equal to 20 mol % and less than or equal to 25 mol %, or any and all sub-ranges formed from any of these endpoints.

The glass compositions and the resultant glass-ceramic articles described herein further comprise alkali metal oxides other than Li₂O, such as Na₂O and K₂O. In addition to aiding in ion exchangeability of the resulting glass-ceramic article, Na₂O decreases the melting point and improves formability of the resulting glass-ceramic article. In embodiments, the glass composition and the resultant glass-ceramic article may comprise greater than or equal to 0.05 mol % and less than or equal to 5 mol % Na₂O. In embodiments, the glass composition and the resultant glass-ceramic article may comprise greater than 0.10 mol % and less than or equal to 5 mol % Na₂O. In embodiments, the glass composition and the resultant glass-ceramic article may comprise greater than or equal to 0.10 mol % and less than or equal to 4.5 mol % Na₂O. In embodiments, the concentration of Na₂O in the glass composition and the resultant glass-ceramic article may be greater than or equal to 0.05 mol %, greater than or equal to 0.10 mol %, greater than or equal to 0.25 mol %, or even greater than or equal to 0.5 mol %. In embodiments, the concentration of Na₂O in the glass composition and the resultant glass-ceramic article may be less than or equal to 5 mol %, less than or equal to 4.5 mol %, less than or equal to 4 mol %, less than or equal to 3.5 mol %, less than or equal to 3 mol %, less than or equal to 2.5 mol %, or even less than or equal to 2 mol %. In embodiments, the concentration of Na₂O in the glass composition and the resultant glass-ceramic article may be greater than or equal to 0.05 mol % and less than or equal to 5 mol %, greater than or equal to 0.05 mol % and less than or equal to 4.5 mol %, greater than or equal to 0.05 mol % and less than or equal to 4 mol %, greater than or equal to 0.05 mol % and less than or equal to 3.5 mol %, greater than or equal to 0.05 mol % and less than or equal to 3 mol %, greater than or equal to 0.05 mol % and less than or equal to 2.5 mol %, greater than or equal to 0.05 mol % and less than or equal to 2 mol %, greater than or equal to 0.10 mol % and less than or equal to 5 mol %, greater than or equal to 0.10 mol % and less than or equal to 4.5 mol %, greater than or equal to 0.10 mol % and less than or equal to 4 mol %, greater than or equal to 0.10 mol % and less than or equal to 3.5 mol %, greater than or equal to 0.10 mol % and less than or equal to 3 mol %, greater than or equal to 0.10 mol % and less than or equal to 2.5 mol %, greater than or equal to 0.10 mol % and less than or equal to 2 mol %, greater than or equal to 0.25 mol % and less than or equal to 5 mol %, greater than or equal to 0.25 mol % and less than or equal to 4.5 mol %, greater than or equal to 0.25 mol % and less than or equal to 4 mol %, greater than or equal to 0.25 mol % and less than or equal to 3.5 mol %, greater than or equal to 0.25 mol % and less than or equal to 3 mol %, greater than or equal to 0.25 mol % and less than or equal to 2.5 mol %, greater than or equal to 0.25 mol % and less than or equal to 2 mol %, greater than or equal to 0.5 mol % and less than or equal to 5 mol %, greater than or equal to 0.5 mol % and less than or equal to 4.5 mol %, greater than or equal to 0.5 mol % and less than or equal to 4 mol %, greater than or equal to 0.5 mol % and less than or equal to 3.5 mol %, greater than or equal to 0.5 mol % and less than or equal to 3 mol %, greater than or equal to 0.5 mol % and less than or equal to 2.5 mol %, or even greater than or equal to 0.5 mol % and less than or equal to 2 mol %, or any and all sub-ranges formed from any of these endpoints.

K₂O promotes ion exchange, increases the depth of compression, and decreases the melting point to improve formability of the resulting glass-ceramic article. In embodiments, the glass composition and the resultant glass-ceramic article may comprise greater than or equal to 0.05 mol % and less than or equal to 3 mol % K₂O. In embodiments, the glass composition and the resultant glass-ceramic article may comprise greater than or equal to 0.10 mol % and less than or equal to 3 mol % K₂O. In embodiments, the glass composition and the resultant glass-ceramic article may comprise greater than or equal to 0.10 mol % and less than or equal to 2.5 mol % K₂O. In embodiments, the concentration of K₂O in the glass composition and the resultant glass-ceramic article may be greater than or equal to 0.05 mol %, greater than or equal to 0.10 mol %, or even greater than or equal to 0.2 mol %. In embodiments, the concentration of K₂O in the glass composition and the resultant glass-ceramic article may be less than or equal to 3 mol %, less than or equal to 2.5 mol %, less than or equal to 2 mol %, less than or equal to 1.5 mol %, less than or equal to 1 mol %, or even less than or equal to 0.5 mol %. In embodiments, the concentration of K₂O in the glass composition and the resultant glass-ceramic article may be greater than or equal to 0.05 mol % and less than or equal to 3 mol %, greater than or equal to 0.05 mol % and less than or equal to 2.5 mol %, greater than or equal to 0.05 mol % and less than or equal to 2 mol %, greater than or equal to 0.05 mol % and less than or equal to 1.5 mol %, greater than or equal to 0.05 mol % and less than or equal to 1 mol %, greater than or equal to 0.05 mol % and less than or equal to 0.5 mol %, greater than or equal to 0.10 mol % and less than or equal to 3 mol %, greater than or equal to 0.10 mol % and less than or equal to 2.5 mol %, greater than or equal to 0.10 mol % and less than or equal to 2 mol %, greater than or equal to 0.10 mol % and less than or equal to 1.5 mol %, greater than or equal to 0.10 mol % and less than or equal to 1 mol %, greater than or equal to 0.10 mol % and less than or equal to 0.5 mol %, greater than or equal to 0.2 mol % and less than or equal to 3 mol %, greater than or equal to 0.2 mol % and less than or equal to 2.5 mol %, greater than or equal to 0.2 mol % and less than or equal to 2 mol %, greater than or equal to 0.2 mol % and less than or equal to 1.5 mol %, greater than or equal to 0.2 mol % and less than or equal to 1 mol %, or even greater than or equal to 0.2 mol % and less than or equal to 0.5 mol %, or any and all sub-ranges formed from any of these endpoints.

In embodiments, the sum (in mol %) of Na₂O and K₂O (i.e., Na₂O (mol %)+K₂O (mol %) in the glass composition and the resultant glass-ceramic article may be greater than or equal to 0.1 mol % to ensure ion exchangeability of the resulting glass-ceramic article. Na₂O+K₂O in the glass composition and the resultant glass-ceramic article may be minimized (e.g., less than or equal to 8 mol %) to ensure a desired central tension is achieved. In embodiments, Na₂O+K₂O in the glass composition and the resultant glass-ceramic article may be greater than or equal to 0.2 mol % and less than or equal to 8 mol %. In embodiments, Na₂O+K₂O in the glass composition and the resultant glass-ceramic article may be greater than or equal to 0.1 mol %, greater than or equal to 0.2 mol %, greater than or equal to 0.4 mol %, or even greater than or equal to 0.6 mol %. In embodiments, Na₂O+K₂O in the glass composition and the resultant glass-ceramic article may be less than or equal to 8 mol %, less than or equal to 7 mol %, less than or equal to 6 mol %, less than or equal to 5 mol %, less than or equal to 4 mol %, less than or equal to 3 mol %, or even less than or equal to 2 mol %. In embodiments, Na₂O+K₂O in the glass composition and the resultant glass-ceramic article may be greater than or equal to 0.1 mol % and less than or equal to 8 mol %, greater than or equal to 0.1 mol % and less than or equal to 7 mol %, greater than or equal to 0.1 mol % and less than or equal to 6 mol %, greater than or equal to 0.1 mol % and less than or equal to 5 mol %, greater than or equal to 0.1 mol % and less than or equal to 4 mol %, greater than or equal to 0.1 mol % and less than or equal to 3 mol %, greater than or equal to 0.1 mol % and less than or equal to 2 mol %, greater than or equal to 0.2 mol % and less than or equal to 8 mol %, greater than or equal to 0.2 mol % and less than or equal to 7 mol %, greater than or equal to 0.2 mol % and less than or equal to 6 mol %, greater than or equal to 0.2 mol % and less than or equal to 5 mol %, greater than or equal to 0.2 mol % and less than or equal to 4 mol %, greater than or equal to 0.2 mol % and less than or equal to 3 mol %, greater than or equal to 0.2 mol % and less than or equal to 2 mol %, greater than or equal to 0.4 mol % and less than or equal to 8 mol %, greater than or equal to 0.4 mol % and less than or equal to 7 mol %, greater than or equal to 0.4 mol % and less than or equal to 6 mol %, greater than or equal to 0.4 mol % and less than or equal to 5 mol %, greater than or equal to 0.4 mol % and less than or equal to 4 mol %, greater than or equal to 0.4 mol % and less than or equal to 3 mol %, greater than or equal to 0.4 mol % and less than or equal to 2 mol %, greater than or equal to 0.6 mol % and less than or equal to 8 mol %, greater than or equal to 0.6 mol % and less than or equal to 7 mol %, greater than or equal to 0.6 mol % and less than or equal to 6 mol %, greater than or equal to 0.6 mol % and less than or equal to 5 mol %, greater than or equal to 0.6 mol % and less than or equal to 4 mol %, greater than or equal to 0.6 mol % and less than or equal to 3 mol %, or even greater than or equal to 0.6 mol % and less than or equal to 2 mol %, or any and all sub-ranges formed from any of these endpoints.

In embodiments, a ratio of Na₂O to the sum of Na₂O+K₂O (i.e., Na₂O (mol %)/(Na₂O (mol %)+K₂O (mol %))) in the glass composition may be greater than or equal to 0.02 and less than or equal to 0.99 to ensure a relatively high peak surface compressive stress is achieved. In embodiments, Na₂O/(Na₂O+K₂O) in the glass composition may be greater than or equal to 0.02, greater than or equal to 0.05, greater than or equal to 0.1, greater than or equal to 0.2, greater than or equal to 0.3, greater than or equal to 0.4, or even greater than or equal to 0.5. In embodiments, Na₂O/(Na₂O+K₂O) in the glass composition may be less than or equal to 0.99, less than or equal to 0.9, less than or equal to 0.8, or even less than or equal to 0.7. In embodiments, Na₂O/(Na₂O+K₂O) in the glass composition may be greater than or equal to 0.02 and less than or equal to 0.99, greater than or equal to 0.02 and less than or equal to 0.9, greater than or equal to 0.02 and less than or equal to 0.8, greater than or equal to 0.02 and less than or equal to 0.7, greater than or equal to 0.05 and less than or equal to 0.99, greater than or equal to 0.05 and less than or equal to 0.9, greater than or equal to 0.05 and less than or equal to 0.8, greater than or equal to 0.05 and less than or equal to 0.7, greater than or equal to 0.1 and less than or equal to 0.99, greater than or equal to 0.1 and less than or equal to 0.9, greater than or equal to 0.1 and less than or equal to 0.8, greater than or equal to 0.1 and less than or equal to 0.7, greater than or equal to 0.2 and less than or equal to 0.99, greater than or equal to 0.2 and less than or equal to 0.9, greater than or equal to 0.2 and less than or equal to 0.8, greater than or equal to 0.2 and less than or equal to 0.7, greater than or equal to 0.3 and less than or equal to 0.99, greater than or equal to 0.3 and less than or equal to 0.9, greater than or equal to 0.3 and less than or equal to 0.8, greater than or equal to 0.3 and less than or equal to 0.7, greater than or equal to 0.4 and less than or equal to 0.99, greater than or equal to 0.4 and less than or equal to 0.9, greater than or equal to 0.4 and less than or equal to 0.8, greater than or equal to 0.4 and less than or equal to 0.7, greater than or equal to 0.5 and less than or equal to 0.99, greater than or equal to 0.5 and less than or equal to 0.9, greater than or equal to 0.5 and less than or equal to 0.8, or even greater than or equal to 0.5 and less than or equal to 0.7, or any and all sub-ranges formed from any of these endpoints.

The glass compositions and the resultant glass-ceramic articles described herein further include P₂O₅. P₂O₅ serves as a nucleating agent to produce bulk nucleation of the crystalline phase in the glass, thereby transforming the glass composition into a glass-ceramic article. The concentration of P₂O₅ in the glass compositions should be sufficiently high (i.e., greater than or equal to 0.2 mol %) to achieve crystallization. The concentration of P₂O₅ may be limited (e.g., less than or equal to 2 mol %) to reduce devitrification during forming and to reduce the liquidus temperature. In embodiments, the glass composition and the resultant glass-ceramic article may comprise greater than or equal to 0.2 mol % and less than or equal to 2 mol % P₂O₅. In embodiments, the glass composition and the resultant glass-ceramic article may comprise greater than or equal to 0.4 mol % and less than or equal to 1.75 mol % P₂O₅. In embodiments, the concentration of P₂O₅ in the glass composition and the resultant glass-ceramic article may be greater than or equal to 0.2 mol %, greater than or equal to 0.4 mol %, greater than or equal to 0.6 mol %, greater than or equal to 0.8 mol %, or even greater than or equal to 1 mol %. In embodiments, the concentration of P₂O₅ in the glass composition and the resultant glass-ceramic article may be less than or equal to 2 mol %, less than or equal to 1.75 mol %, or even less than or equal to 1.5 mol %. In embodiments, the concentration of P₂O₅ in the glass composition and the resultant glass-ceramic article may be greater than or equal to 0.2 mol % and less than or equal to 2 mol %, greater than or equal to 0.2 mol % and less than or equal to 1.75 mol %, greater than or equal to 0.2 mol % and less than or equal to 1.5 mol %, greater than or equal to 0.4 mol % and less than or equal to 2 mol %, greater than or equal to 0.4 mol % and less than or equal to 1.75 mol %, greater than or equal to 0.4 mol % and less than or equal to 1.5 mol %, greater than or equal to 0.6 mol % and less than or equal to 2 mol %, greater than or equal to 0.6 mol % and less than or equal to 1.75 mol %, greater than or equal to 0.6 mol % and less than or equal to 1.5 mol %, greater than or equal to 0.8 mol % and less than or equal to 2 mol %, greater than or equal to 0.8 mol % and less than or equal to 1.75 mol %, greater than or equal to 0.8 mol % and less than or equal to 1.5 mol %, greater than or equal to 1 mol % and less than or equal to 2 mol %, greater than or equal to 1 mol % and less than or equal to 1.75 mol %, or even greater than or equal to 1 mol % and less than or equal to 1.5 mol %, or any and all sub-ranges formed from any of these endpoints.

The compositions and the resultant glass-ceramic articles described herein further include ZrO₂. ZrO₂ may help facilitate ion exchange by solubilizing Li₂O, thereby increasing maximum central tension and higher peak surface compressive stress. ZrO₂ also may help decrease grain size, which may be important to the formation of a transparent glass-ceramic article. Like SiO₂, ZrO₂ may function as a network former, thereby improving the stability of the glass by reducing devitrification during forming and reducing liquidus temperature. The addition of ZrO₂ may also improve the chemical durability of the resulting glass-ceramic article. In embodiments, the glass composition and the resultant glass-ceramic article may comprise greater than or equal to 1.5 mol % and less than or equal to 10 mol % ZrO₂. In embodiments, the glass composition and the resultant glass-ceramic article may comprise greater than or equal to 2 mol % and less than or equal to 9 mol % ZrO₂. In embodiments, the concentration of ZrO₂ in the glass composition and the resultant glass-ceramic article may be greater than or equal to 1.5 mol %, greater than or equal to 2 mol %, greater than or equal to 2.5 mol %, or even greater than or equal to 3 mol %. In embodiments, the concentration of ZrO₂ in the glass composition and the resultant glass-ceramic article may be less than or equal to 10 mol %, less than or equal to 9 mol %, less than or equal to 7 mol %, or even less than or equal to 5 mol %. In embodiments, the concentration of ZrO₂ in the glass composition and the resultant glass-ceramic article may be greater than or equal to 1.5 mol % and less than or equal to 10 mol %, greater than or equal to 1.5 mol % and less than or equal to 9 mol %, greater than or equal to 1.5 mol % and less than or equal to 7 mol %, greater than or equal to 1.5 mol % and less than or equal to 5 mol %, greater than or equal to 2 mol % and less than or equal to 10 mol %, greater than or equal to 2 mol % and less than or equal to 9 mol %, greater than or equal to 2 mol % and less than or equal to 7 mol %, greater than or equal to 2 mol % and less than or equal to 5 mol %, greater than or equal to 2.5 mol % and less than or equal to 10 mol %, greater than or equal to 2.5 mol % and less than or equal to 9 mol %, greater than or equal to 2.5 mol % and less than or equal to 7 mol %, greater than or equal to 2.5 mol % and less than or equal to 5 mol %, greater than or equal to 3 mol % and less than or equal to 10 mol %, greater than or equal to 3 mol % and less than or equal to 9 mol %, greater than or equal to 3 mol % and less than or equal to 7 mol %, or even greater than or equal to 3 mol % and less than or equal to 5 mol %, or any and all sub-ranges formed from any of these endpoints.

In embodiments, the glass compositions and the resultant glass-ceramic articles described herein may further comprise SnO₂ as a fining agent. In embodiments, the concentration of SnO₂ in the glass composition and the resultant glass-ceramic article may be greater than or equal to 0 mol % or even greater than or equal to 0.1 mol %. In embodiments, the concentration of SnO₂ in the glass composition and the resultant glass-ceramic article may be less than or equal to 1 mol %, less than or equal to 0.5 mol %, or even less than or equal to 0.25 mol %. In embodiments, the concentration of SnO₂ in the glass composition and the resultant glass-ceramic article may be greater than or equal to 0 mol % and less than or equal to 1 mol %, greater than or equal to 0 mol % and less than or equal to 0.5 mol %, greater than or equal to 0 mol % and less than or equal to 0.25 mol %, greater than or equal to 0.1 mol % and less than or equal to 1 mol %, greater than or equal to 0.1 mol % and less than or equal to 0.5 mol %, or even greater than or equal to 0.1 mol % and less than or equal to 0.25 mol %, or any and all sub-ranges formed from any of these endpoints. In embodiments, the glass composition and the resultant glass-ceramic article may be free or substantially free of SnO₂.

In embodiments, the glass compositions and the resultant glass-ceramic articles described herein may further include tramp materials such as TiO₂, MnO, MoO₃, WO₃, Y₂O₃, CdO, As₂O₃, Sb₂O₃, sulfur-based compounds, such as sulfates, halogens, or combinations thereof. In embodiments, the glass compositions and the resultant glass-ceramic articles may be substantially free or free of individual tramp materials, a combination of tramp materials, or all tramp materials. For example, in embodiments, the glass compositions and the resultant glass-ceramic articles may be substantially free or free of TiO₂, MnO, MoO₃, WO₃, Y₂O₃, CdO, As₂O₃, Sb₂O₃, sulfur-based compounds, such as sulfates, halogens, or combinations thereof.

In embodiments, antimicrobial components, chemical fining agents, or other additional components may be included in the glass compositions and the resultant glass-ceramic articles.

In embodiments, a liquidus temperature of the glass composition may be greater than or equal to 800° C. and less than or equal to 1400° C. In embodiments, a liquidus temperature of the glass composition may be greater than or equal to 800° C., greater than or equal to 900° C., or even greater than or equal to 1000° C. In embodiments, a liquidus temperature of the glass composition may be less than or equal to 1400° C., less than or equal to 1300° C., or even less than or equal to 1200° C. In embodiments, a liquidus temperature of the glass composition may be greater than or equal to 800° C. and less than or equal to 1400° C., greater than or equal to 800° C. and less than or equal to 1300° C., greater than or equal to 800° C. and less than or equal to 1200° C., greater than or equal to 900° C. and less than or equal to 1400° C., greater than or equal to 900° C. and less than or equal to 1300° C., greater than or equal to 900° C. and less than or equal to 1200° C., greater than or equal to 1000° C. and less than or equal to 1400° C., greater than or equal to 1000° C. and less than or equal to 1300° C., or even greater than or equal to 1000° C. and less than or equal to 1200° C., or any and all sub-ranges formed from any of these endpoints.

In embodiments, a liquidus viscosity of the glass composition may be greater than or equal to 0.25 kilopoise (kP) and less than or equal to 5 kP. In embodiments, a liquidus viscosity of the glass composition may be greater than or equal to 0.25 kP, greater than or equal to 0.5 kP, or even greater than or equal to 1 kP. In embodiments, a liquidus viscosity of the glass composition may be less than or equal to 5 kP, less than or equal to 4 kP, or even less than or equal to 3 kP.

The precursor glass articles or the glass-ceramic articles formed therefrom as described herein described herein may be any suitable thickness, which may vary depending on the particular application of the glass-ceramic article. In embodiments, the precursor glass articles and the glass-ceramic articles formed thereform may have a thickness greater than or equal to 250 μm and less than or equal to 6 mm, greater than or equal to 250 μm and less than or equal to 4 mm, greater than or equal to 250 μm and less than or equal to 2 mm, greater than or equal to 250 μm and less than or equal to 1 mm, greater than or equal to 250 μm and less than or equal to 750 μm, greater than or equal to 250 μm and less than or equal to 500 μm, greater than or equal to 500 μm and less than or equal to 6 mm, greater than or equal to 500 μm and less than or equal to 4 mm, greater than or equal to 500 μm and less than or equal to 2 mm, greater than or equal to 500 μm and less than or equal to 1 mm, greater than or equal to 500 μm and less than or equal to 750 μm, greater than or equal to 750 μm and less than or equal to 6 mm, greater than or equal to 750 μm and less than or equal to 4 mm, greater than or equal to 750 μm and less than or equal to 2 mm, greater than or equal to 750 μm and less than or equal to 1 mm, greater than or equal to 1 mm and less than or equal to 6 mm, greater than or equal to 1 mm and less than or equal to 4 mm, greater than or equal to 1 mm and less than or equal to 2 mm, greater than or equal to 2 mm and less than or equal to 6 mm, greater than or equal to 2 mm and less than or equal to 4 mm, or even greater than or equal to 4 mm and less than or equal to 6 mm, or any and all sub-ranges formed from any of these endpoints.

In embodiments, the processes for making the glass-ceramic article include heat treating a precursor glass article formed from a glass composition in an oven at one or more preselected temperatures for one or more preselected times to induce crystallization (i.e., nucleation and growth) of one or more crystalline phases (e.g., having one or more compositions, amounts, morphologies, sizes or size distributions, etc.). In embodiments, the heat treatment may include (i) heating a precursor glass article in an oven at a rate greater than or equal to 1° C./min and less than or equal to 10° C./min to a nucleation temperature; (ii) maintaining the precursor glass article at the nucleation temperature in the oven for a nucleation time greater than or equal to 0.1 hour and less than or equal to 8 hours to produce a nucleated crystallizable glass; (iii) heating the nucleated crystallizable glass article in the oven at a rate greater than or equal to 1° C./min and less than or equal to 10° C./min to a crystallization temperature; (iv) maintaining the nucleated crystallizable glass article at the crystallization temperature in the oven for a crystallization time greater than or equal to 0.1 hour and less than or equal to 8 hours to produce the glass-ceramic article; and (v) cooling the glass-ceramic article to room temperature.

In embodiments, the nucleation temperature may be greater than or equal to 500° C. or even greater than or equal to 550° C. In embodiments, the nucleation temperature may be less than or equal to 650° C. or even less than or equal to 600° C. In embodiments, the nucleation temperature may be greater than or equal to 500° C. and less than or equal to 650° C., greater than or equal to 500° C. and less than or equal to 600° C., greater than or equal to 550° C. and less than or equal to 650° C., greater than or equal to 550° C. and less than or equal to 600° C., or any and all sub-ranges formed from any of these endpoints.

In embodiments, the nucleation time may be greater than or equal to 0.1 hour and less than or equal to 8 hours. In embodiments, the nucleation time may be greater than or equal to 0.1 hour, greater than or equal to 0.5 hour, greater than or equal to 1 hour, or even greater than or equal to 2 hours. In embodiments, the nucleation time may be less than or equal to 8 hours, less than or equal to 6 hours, or even less than or equal to 4 hours. In embodiments, the nucleation time may be greater than or equal to 0.1 hour and less than or equal to 8 hours, greater than or equal to 0.1 hour and less than or equal to 6 hours, greater than or equal to 0.1 hour and less than or equal to 4 hours, greater than or equal to 0.5 hour and less than or equal to 8 hours, greater than or equal to 0.5 hour and less than or equal to 6 hours, greater than or equal to 0.5 hour and less than or equal to 4 hours, greater than or equal to 1 hour and less than or equal to 8 hours, greater than or equal to 1 hour and less than or equal to 6 hours, greater than or equal to 1 hour and less than or equal to 4 hours, greater than or equal to 2 hours and less than or equal to 8 hours, greater than or equal to 2 hours and less than or equal to 6 hours, or even greater than or equal to 2 hours and less than or equal to 4 hours, or any and all sub-ranges formed from any of these endpoints.

In embodiments, the crystallization temperature may be greater than or equal to 650° C. or even greater than or equal to 700° C. In embodiments, the crystallization temperature may be less than or equal to 850° C. or even less than or equal to 800° C. In embodiments, the crystallization temperature may be greater than or equal to 650° C. and less than or equal to 850° C., greater than or equal to 650° C. and less than or equal to 800° C., greater than or equal to 700° C. and less than or equal to 850° C., or even greater than or equal to 700° C. and less than or equal to 800° C., or any and all sub-ranges formed from any of these endpoints.

In embodiments, the crystallization time may be greater than or equal to 0.25 hour and less than or equal to 4 hours. In embodiments, the crystallization time may be greater than or equal to 0.25 hour or even greater than or equal to 0.5 hour. In embodiments, the crystallization time may be less than or equal to 4 hours or even less than or equal to 2 hours. In embodiments, the crystallization time may be greater than or equal to 0.25 hour and less than or equal to 4 hours, greater than or equal to 0.25 hour and less than or equal to 2 hours, greater than or equal to 0.5 hour and less than or equal to 4 hours, or even greater than or equal to 0.5 hour and less than or equal to 2 hours, or any and all sub-ranges formed from any of these endpoints.

As utilized herein, the heating rates, nucleation temperature, and crystallization temperature refer to the heating rate and temperature of the oven in which the glass composition or precursor glass article is being heat treated.

In addition to the glass compositions, temperature-temporal profiles of heat treatment steps of heating to the crystallization temperature and maintaining the temperature at the crystallization temperature are judiciously prescribed so as to produce one or more of the following desired attributes: crystalline phase(s) of the glass-ceramic article, proportions of one or more major crystalline phases and/or one or more minor crystalline phases and residual glass phases, crystal phase assemblages of one or more predominate crystalline phases and/or one or more minor crystalline phases and residual glass phases, and grain sizes or grain size distribution among one or more major crystalline phases and/or one or more minor crystalline phases, which in turn may influence the final integrity, quality, color, and/or opacity of the resulting glass-ceramic article.

The glass-ceramic articles described herein include a crystalline phase and a residual glass phase. In embodiments, the crystalline phase may comprise a lithium disilicate sub-phase. Lithium disilicate, Li₂Si₂O₅, is an orthorhombic crystal based on corrugated sheets of {Si₂O₅} tetrahedral arrays. The crystals are typically tabular or lath-like in shape, with pronounced cleavage planes. Glass-ceramic articles based on lithium disilicate offer highly desirable mechanical properties, including high body strength and fracture toughness, due to their microstructures of randomly-oriented interlocked crystals—a crystal structure that forces cracks to propagate through the material via tortuous paths around these crystals.

In embodiments, the lithium disilicate sub-phase may be present in a greater amount, based on a total weight of the crystalline phase, than any other sub-phase in the crystalline phase. In embodiments, the total amount of the lithium disilicate sub-phase in the crystalline phase, based on a total weight of the crystalline phase, may be greater than or equal to 30 wt %, greater than or equal to 40 wt %, greater than or equal to 50 wt %, greater than or equal to or equal to 60 wt %, or even greater than or equal to 70 wt %. In embodiments, the total amount of the lithium disilicate sub-phase in the crystalline phase, based on a total weight of the crystalline phase, may be less than or equal to 99 wt %, less than or equal to 90 wt %, or even less than or equal to 80 wt %. In embodiments, the total amount of the lithium disilicate sub-phase in the crystalline phase, based on a total weight of the crystalline phase, may be greater than or equal to 30 wt % and less than or equal to 99 wt %, greater than or equal to 30 wt % and less than or equal to 90 wt %, greater than or equal to 30 wt % and less than or equal to 80 wt %, greater than or equal to 40 wt % and less than or equal to 99 wt %, greater than or equal to 40 wt % and less than or equal to 90 wt %, greater than or equal to 40 wt % and less than or equal to 80 wt %, greater than or equal to 50 wt % and less than or equal to 99 wt %, greater than or equal to 50 wt % and less than or equal to 90 wt %, greater than or equal to 50 wt % and less than or equal to 80 wt %, greater than or equal to 60 wt % and less than or equal to 99 wt %, greater than or equal to 60 wt % and less than or equal to 90 wt %, greater than or equal to 60 wt % and less than or equal to 80 wt %, greater than or equal to 70 wt % and less than or equal to 99 wt %, greater than or equal to 70 wt % and less than or equal to 90 wt %, or even greater than or equal to 70 wt % and less than or equal to 80 wt %, or any and all sub-ranges formed from any of these endpoints.

In embodiments, in addition to the lithium disilicate sub-phase, the crystalline phase of the glass-ceramic article may further comprise a lithium metasilicate sub-phase, a lithium phosphate sub-phase, a petalite sub-phase, a cristobalite sub-phase, or combinations thereof.

In embodiments, the glass-ceramic article may comprise greater than or equal to 35 wt % and less than or equal to 80 wt % of the crystalline phase, based on a total weight of the glass-ceramic article, with a remainder of the glass-ceramic article comprising the residual glass phase, as determined according to Rietveld analysis of the XRD spectrum. In embodiments, the glass-ceramic article may comprise greater than or equal to 35 wt %, greater than or equal to 40 wt %, greater than or equal to 45 wt %, or even greater than or equal to 50 wt % of the crystalline phase, based on a total weight of the glass-ceramic article, with a remainder of the glass-ceramic article comprising the residual glass phase, as determined according to Rietveld analysis of the XRD spectrum. In embodiments, the glass-ceramic article may comprise less than or equal to 80 wt %, less than or equal to 75 wt %, less than or equal to 70 wt %, or even less than or equal to 65 wt % of the crystalline phase, based on a total weight of the glass-ceramic article, with a remainder of the glass-ceramic article comprising the residual glass phase, as determined according to Rietveld analysis of the XRD spectrum. In embodiments, the glass-ceramic article may comprise greater than or equal to 35 wt % and less than or equal to 80 wt %, greater than or equal to 35 wt % and less than or equal to 75 wt %, greater than or equal to 35 wt % and less than or equal to 70 wt %, greater than or equal to 35 wt % and less than or equal to 65 wt %, greater than or equal to 40 wt % and less than or equal to 80 wt %, greater than or equal to 40 wt % and less than or equal to 75 wt %, greater than or equal to 40 wt % and less than or equal to 70 wt %, greater than or equal to 40 wt % and less than or equal to 65 wt %, greater than or equal to 45 wt % and less than or equal to 80 wt %, greater than or equal to 45 wt % and less than or equal to 75 wt %, greater than or equal to 45 wt % and less than or equal to 70 wt %, greater than or equal to 45 wt % and less than or equal to 65 wt %, greater than or equal to 50 wt % and less than or equal to 80 wt %, greater than or equal to 50 wt % and less than or equal to 75 wt %, greater than or equal to 50 wt % and less than or equal to 70 wt %, or even greater than or equal to 50 wt % and less than or equal to 65 wt %, or any and all sub-ranges formed from any of these endpoints, of the crystalline phase, based on a total weight of the glass-ceramic article, with a remainder of the glass-ceramic article comprising the residual glass phase, as determined according to Rietveld analysis of the XRD spectrum.

As discussed hereinabove, glass-ceramic articles formed from the glass compositions described herein may have an increased fracture toughness such that the glass-ceramic articles are more resistant to damage. In embodiments, the glass-ceramic article may have a K_{Ic} fracture toughness as measured by a chevron notched short bar method greater than or equal to 1.1 MPa·m^{1/2}. In embodiments, the glass-ceramic article may have a K_{Ic} fracture toughness as measured by a chevron notched short bar method greater than or equal to 1.1 MPa·m^{1/2} or even greater than or equal to 1.2 MPa·m^{1/2}.

In embodiments, an elastic modulus of a glass-ceramic article may be greater than or equal to 95 GPa. In embodiments, an elastic modulus of the glass-ceramic article may be greater than or equal to 95 GPa or even greater than or equal to 100 GPa. In embodiments, an elastic modulus of the glass-ceramic article may be less than or equal to 125 GPa or even less than or equal to 115 GPa. In embodiments, an elastic modulus of the glass-ceramic article may be greater than or equal to 95 GPa and less than or equal to 125 GPa, greater than or equal to 95 GPa and less than or equal to 115 GPa, greater than or equal to 100 GPa and less than or equal to 125 GPa, or even greater than or equal to 100 GPa and less than or equal to 115 GPa, or any and all sub-ranges formed from any of these endpoints.

In embodiments, a shear modulus of a glass-ceramic article may be greater than or equal to 30 GPa or even greater than or equal to 40 GPa. In embodiments, a shear modulus of a glass-ceramic article may be less than or equal to 60 GPa or even less than or equal to 50 GPa. In embodiments, a shear modulus of a glass-ceramic article may be greater than or equal to 30 GPa and less than or equal to 60 GPa, greater than or equal to 30 GPa and less than or equal to 50 GPa, greater than or equal to 40 GPa and less than or equal to 60 GPa, or even greater than or equal to 40 GPa and less than or equal to 50 GPa, or any and all sub-ranges formed from any of these endpoints.

In embodiments, a Poisson's ratio of a glass-ceramic article may be greater than or equal to 0.17 or even greater than or equal to 0.19. In embodiments, a Poisson's ratio of the glass-ceramic article may be less than or equal to 0.23 or even less than or equal to 0.21. In embodiments, a Poisson's ratio of the glass-ceramic article may be greater than or equal to 0.17 and less than or equal to 0.23, greater than or equal to 0.17 and less than or equal to 0.21, greater than or equal to 0.19 and less than or equal to 0.23, or even greater than or equal to 0.19 and less than or equal to 0.21, or any and all sub-ranges formed from any of these endpoints.

In embodiments, the glass-ceramic article may have a haze less than or equal to 0.5, less than or equal to 0.4, or even less than or equal to 0.3, as measured at an article thickness of 0.6 mm. In embodiments, the glass-ceramic article may be transparent.

In embodiments, the glass-ceramic articles described herein are ion exchangeable to strengthen the article. In typical ion exchange processes, smaller metal ions in the glass-ceramic article are replaced or “exchanged” with larger metal ions of the same valence within a layer that is close to the outer surface of the glass-ceramic article. The replacement of smaller ions with larger ions creates a compressive stress within the layer of the glass-ceramic article. In embodiments, the metal ions are monovalent metal ions (e.g., Li⁺, Na⁺, K⁺, and the like), and ion exchange is accomplished by immersing the glass-ceramic article in a bath comprising at least one molten salt of the larger metal ion that is to replace the smaller metal ion in the glass-ceramic article. Alternatively, other monovalent ions such as Ag⁺, Tl⁺, Cu⁺, and the like may be exchanged for monovalent ions. The ion exchange process or processes that are used to strengthen the glass-ceramic article may include, but are not limited to, immersion in a single bath or multiple baths of like or different compositions with optional washing and/or annealing steps between immersions.

Upon exposure to the glass-ceramic article, the ion exchange solution (e.g., KNO₃, and/or NaNO₃ molten salt bath; LiNO₃ may also be included in the bath in small amounts (e.g., less than 2 wt %)) may, according to embodiments, be at a temperature greater than or equal to 350° C. and less than or equal to 550° C., greater than or equal to 350° C. and less than or equal to 525° C., greater than or equal to 350° C. and less than or equal to 500° C., greater than or equal to 350° C. and less than or equal to 475° C., greater than or equal to 375° C. and less than or equal to 550° C., greater than or equal to 375° C. and less than or equal to 525° C., greater than or equal to 375° C. and less than or equal to 500° C., greater than or equal to 375° C. and less than or equal to 475° C., greater than or equal to 400° C. and less than or equal to 550° C., greater than or equal to 400° C. and less than or equal to 525° C., greater than or equal to 400° C. and less than or equal to 500° C., greater than or equal to 400° C. and less than or equal to 475° C., greater than or equal to 425° C. and less than or equal to 550° C., greater than or equal to 425° C. and less than or equal to 525° C., greater than or equal to 425° C. and less than or equal to 500° C., or even greater than or equal to 425° C. and less than or equal to 475° C., or any and all sub-ranges formed from any of these endpoints. In embodiments, the glass-ceramic article may be exposed to a first ion exchange solution (i.e., a first ion exchange bath) for a duration greater than or equal to 2 hours and less than or equal to 12 hours, greater than or equal to 2 hours and less than or equal to 8 hours, greater than or equal to 4 hours and less than or equal to 12 hours, greater than or equal to 4 hours and less than or equal to 8 hours, or any and all sub-ranges formed from any of these endpoints. In embodiments, the glass-ceramic article may be exposed to a second ion exchange solution (i.e., a second ion exchange bath) for a duration greater than or equal to 0.25 hour and less than or equal to 4 hours, greater than or equal to 0.25 hour and less than or equal to 2 hour, greater than or equal to 0.5 hour and less than or equal to 4 hours, greater than or equal to 0.5 hour and less than or equal to 2 hour, or any and all sub-ranges formed from any of these endpoints.

In embodiments, at least one of the first ion exchange bath and the second ion exchange bath may comprise sodium ions, potassium ions, lithium ions, or combinations thereof. In embodiments, during a first ion exchange step, Li ions present in the residual glass phase of the glass-ceramic article may be replaced with Na ions present the first ion exchange bath, which results in a relatively higher maximum central tension. In embodiments, during a second ion exchange step, Na ions present at the surface of the glass-ceramic article after the first ion exchange step may be replaced with K ion present in the ion exchange bath, thereby increasing the K₂O surface concentration to achieve a relatively high peak surface compressive stress (e.g., greater than or equal to 500 MPa).

In embodiments, the glass-ceramic article, after ion exchange treatment, may have a surface concentration of K₂O greater than or equal to 1 mol %. In embodiments, the glass-ceramic article, after ion exchange treatment, may have a surface concentration of K₂O greater than or equal to 1 mol %, greater than or equal to 2 mol %, greater than or equal to 3 mol %, greater than or equal to 4 mol %, or even greater than or equal to 5 mol %.

As described herein, the glass-ceramic articles may be may be ion exchanged to achieve a relatively high peak surface compressive stress (e.g., greater than or equal to 500 MPa). While not wishing to be bound by theory, it is believed that a relatively high peak surface compressive stress may help minimize subsurface damage, thereby preventing the formation of lateral crack systems. In embodiments, the glass-ceramic article, after ion exchange treatment, may have a peak surface compressive stress greater than or equal to 500 MPa. In embodiments, the glass-ceramic article, after ion exchange treatment, may have a peak surface compressive stress greater than or equal to 500 MPa, greater than or equal to 550 MPa, greater than or equal to 600 MPa, greater than or equal to 650 MPa, or even greater than or equal to 700 MPa. In embodiments, the glass-ceramic article, after ion exchange treatment, may have a peak surface compressive stress less than or equal to 1200 MPa, less than or equal to 1000 MPa, or even less than or equal to 800 MPa. In embodiments, the glass-ceramic article, after ion exchange treatment, may have a peak surface compressive stress greater than or equal to 500 MPa and less than or equal to 1200 MPa, greater than or equal to 500 MPa and less than or equal to 1000 MPa, greater than or equal to 500 MPa and less than or equal to 800 MPa, greater than or equal to 550 MPa and less than or equal to 1200 MPa, greater than or equal to 550 MPa and less than or equal to 1000 MPa, greater than or equal to 550 MPa and less than or equal to 800 MPa, greater than or equal to 600 MPa and less than or equal to 1200 MPa, greater than or equal to 600 MPa and less than or equal to 1000 MPa, greater than or equal to 600 MPa and less than or equal to 800 MPa, greater than or equal to 650 MPa and less than or equal to 1200 MPa, greater than or equal to 650 MPa and less than or equal to 1000 MPa, greater than or equal to 650 MPa and less than or equal to 800 MPa, greater than or equal to 700 MPa and less than or equal to 1200 MPa, greater than or equal to 700 MPa and less than or equal to 1000 MPa, or even greater than or equal to 700 MPa and less than or equal to 800 MPa, or any and all sub-ranges formed from any of these endpoints.

In embodiments, the glass-ceramic article, after ion exchange treatment, may have a depth of layer greater than or equal to 2 μm. In embodiments, the glass-ceramic article, after ion exchange treatment, may have a depth of layer greater than or equal to 2 μm, greater than or equal to 3 μm, greater than or equal to 4 μm, or even greater than or equal to 5 μm.

In embodiments, the glass-ceramic articles may have a thickness “t” and may be ion exchanged to achieve a depth of compression greater than or equal to 0.05t, greater than or equal to 0.1t, or even greater than or equal to 0.15t. In embodiments, the glass-ceramic articles may have a thickness “t” and may be ion exchanged to achieve a depth of compression less than or equal to 0.28t, less than or equal to 0.25t, less than or equal to 0.23t, or even less than or equal to 0.2t. In embodiments, the glass-ceramic articles may have a thickness “t” and may be ion exchanged to achieve a depth of compression greater than or equal to 0.05t and less than or equal to 0.28t, greater than or equal to 0.05t and less than or equal to 0.25t, greater than or equal to 0.05t and less than or equal to 0.23t, greater than or equal to 0.05t and less than or equal to 0.2t, greater than or equal to 0.1t and less than or equal to 0.28t, greater than or equal to 0.1t and less than or equal to 0.25t, greater than or equal to 0.1t and less than or equal to 0.23t, greater than or equal to 0.1t and less than or equal to 0.2t, greater than or equal to 0.15t and less than or equal to 0.28t, greater than or equal to 0.15t and less than or equal to 0.25t, greater than or equal to 0.15t and less than or equal to 0.23t, or even greater than or equal to 0.15t and less than or equal to 0.2t, or any and all sub-ranges formed from any of these endpoints.

In embodiments, the glass-ceramic article, after ion exchange treatment, may have a maximum central tension greater than or equal to 65 MPa. In embodiments, the glass-ceramic article, after ion exchange treatment, may have a maximum central tension greater than or equal to 65 MPa, greater than or equal to 80 MPa, or even greater than or equal to 95 MPa. In embodiments, the glass-ceramic article, after ion exchange treatment, may have a maximum central tension less than or equal to 200 MPa, less than or equal to 175 MPa, less than or equal to 150 MPa, or even less than or equal to 125 MPa. In embodiments, the glass-ceramic article, after ion exchange treatment, may have a maximum central tension greater than or equal to 65 MPa and less than or equal to 200 MPa, greater than or equal to 65 MPa and less than or equal to 175 MPa, greater than or equal to 65 MPa and less than or equal to 150 MPa, greater than or equal to 65 MPa and less than or equal to 125 MPa, greater than or equal to 80 MPa and less than or equal to 200 MPa, greater than or equal to 80 MPa and less than or equal to 175 MPa, greater than or equal to 80 MPa and less than or equal to 150 MPa, greater than or equal to 80 MPa and less than or equal to 125 MPa, greater than or equal to 95 MPa and less than or equal to 200 MPa, greater than or equal to 95 MPa and less than or equal to 175 MPa, greater than or equal to 95 MPa and less than or equal to 150 MPa, or even greater than or equal to 95 MPa and less than or equal to 125 MPa, or any and all sub-ranges formed from any of these endpoints.

In embodiments, the glass-ceramic article may have a widest width of lateral cracking less than or equal to 125 μm, less than or equal to 110 μm, or even less than or equal to 95 μm, when subjected to scratch testing to initiate a scratch with a 10 μm/90 degree angle conospherical tip, a scratch speed of 24 mm/min, and a constant load of 0.5 N. In embodiments, the glass-ceramic article may have a mean width of lateral cracking less than or equal to 100 μm, less than or equal to 90 μm, or even less than or equal to 80 μm, when subjected to scratch testing to initiate a scratch with a 10 μm/90 degree angle conospherical tip, a scratch speed of 24 mm/min, and a constant load of 0.5 N

The glass-ceramic articles described herein may be used for a variety of applications including, for example, for cover glass or glass backplane applications in consumer or commercial electronic devices including, for example, LCD and LED displays, computer monitors, and automated teller machines (ATMs); for touch screen or touch sensor applications, for portable electronic devices including, for example, mobile telephones, personal media players, watches and tablet computers; for integrated circuit applications including, for example, semiconductor wafers; for photovoltaic applications; for architectural glass applications; for automotive or vehicular glass applications; or for commercial or household appliance applications. In embodiments, a consumer electronic device (e.g., smartphones, tablet computers, watches, personal computers, ultrabooks, televisions, and cameras), an architectural glass, and/or an automotive glass may comprise a glass-ceramic article as described herein.

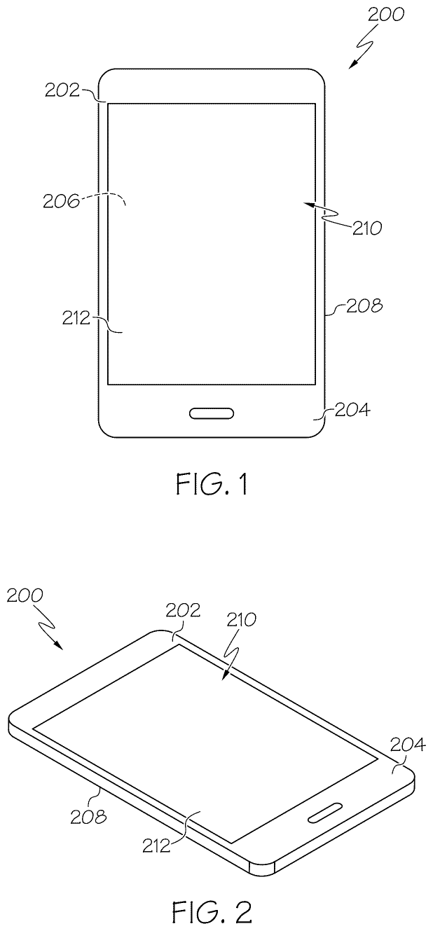

An exemplary electronic device incorporating any of the glass-ceramic articles disclosed herein is shown in FIGS. 1 and 2. Specifically, FIGS. 1 and 2 show a consumer electronic device 200 including a housing 202 having front 204, back 206, and side surfaces 108; electrical components (not shown) that are at least partially inside or entirely within the housing and including at least a controller, a memory, and a display 210 at or adjacent to the front surface of the housing; and a cover substrate 212 at or over the front surface of the housing such that it is over the display. In embodiments, at least a portion of at least one of the cover substrate 212 and the housing 202 may include any of the glass-ceramic articles disclosed herein.

### Examples

In order that various embodiments be more readily understood, reference is made to the following examples, which are intended to illustrate various embodiments of the glass compositions and glass-ceramic articles described herein.

Table 1 shows example glass compositions C1-C13 and comparative glass compositions Z1 and Z2 (in terms of mol %) and the liquidus temperatures and viscosities of the example glass compositions.

TABLE 1

| Example | C1 | C2 | C3 | C4 | C5 | C6 | C7 |
|---|---|---|---|---|---|---|---|
| SiO₂ | 68.7 | 67.8 | 69.1 | 68.4 | 68.7 | 68.3 | 68.0 |
| Al₂O₃ | 2.8 | 2.0 | 2.0 | 2.0 | 2.0 | 2.0 | 2.0 |
| Li₂O | 21.0 | 23.8 | 23.8 | 23.8 | 23.8 | 23.8 | 23.8 |
| Na₂O | 1.9 | 1.3 | 0.2 | 0.1 | 0.2 | 0.2 | 0.2 |
| K₂O | 0.7 | 0.4 | 0.2 | 0.1 | 0.4 | 0.4 | 0.4 |
| P₂O₅ | 1.0 | 1.1 | 1.2 | 1.1 | 1.1 | 1.1 | 1.1 |
| ZrO₂ | 3.8 | 3.5 | 3.5 | 4.5 | 3.9 | 4.3 | 4.5 |
| SnO₂ | 0.1 | — | — | — | — | — | — |
| Na₂O + K₂O | 2.6 | 1.7 | 0.4 | 0.2 | 0.6 | 0.6 | 0.6 |
| Na₂O/ | 0.7 | 0.8 | 0.5 | 0.5 | 0.3 | 0.3 | 0.3 |
| (Na₂O + K₂O) | | | | | | | |
| Liquidus temp. (° C.) | 1065 | 1015 | 1060 | 1145 | 1075 | 1100 | 1165 |
| Liquidus viscosity (kP) | 2.58 | 3.34 | 2.58 | 0.89 | 1.96 | 1.42 | 0.63 |

| Example | C8 | C9 | C10 | C11 | C12 | C13 |
|---|---|---|---|---|---|---|
| SiO₂ | 67.7 | 67.5 | 67.2 | 67.2 | 67.0 | 66.6 |
| Al₂O₃ | 2.0 | 2.0 | 2.0 | 2.0 | 2.0 | 2.0 |
| Li₂O | 23.8 | 23.6 | 23.4 | 23.6 | 23.4 | 23.3 |
| Na₂O | 0.2 | 1.0 | 1.5 | 1.0 | 1.5 | 2.0 |
| K₂O | 0.4 | 0.6 | 0.6 | 0.6 | 0.6 | 0.6 |
| P₂O₅ | 1.1 | 1.1 | 1.1 | 1.1 | 1.1 | 1.1 |
| ZrO₂ | 4.8 | 4.2 | 4.2 | 4.5 | 4.4 | 4.4 |
| SnO₂ | — | — | — | — | — | — |
| Na₂O + K₂O | 0.6 | 1.6 | 2.1 | 1.6 | 2.1 | 2.6 |
| Na₂O/ | 0.3 | 0.6 | 0.7 | 0.6 | 0.7 | 0.8 |
| (Na₂O + K₂O) | | | | | | |
| Liquidus temp. (° C.) | 1195 | 1070 | 1080 | 1110 | 1080 | 1095 |
| Liquidus viscosity (kP) | 0.44 | — | — | — | — | — |

| Example | Z1 | Z2 |
|---|---|---|
| SiO₂ | 70.93 | 68.88 |
| Al₂O₃ | 4.24 | 4.02 |
| Li₂O | 21.72 | 22.39 |
| Na₂O | 0.06 | 0.07 |
| K₂O | 0.07 | 0.07 |
| CaO | — | 0.72 |
| P₂O₅ | 0.86 | 1.02 |
| ZrO₂ | 1.97 | 2.80 |
| SnO₂ | 0.15 | — |
| Na₂O + K₂O | 0.13 | 0.14 |
| Na₂O/ | 0.46 | 0.50 |
| (Na₂O + K₂O) | | |
| Liquidus temp. (° C.) | 1065 | 1065 |
| Liquidus viscosity (kP) | 3.75 | 3.24 |

### Example A— Heat Treatments

Table 2 shows the heat treatment schedule for achieving example and comparative glass-ceramic articles, and the respective properties of the glass-ceramic articles. Example glass-ceramic articles A1-A13 and comparative glass-ceramic articles Y1 and Y2 were produced by heat treating precursor glass articles formed from the example glass compositions C1-C13 and comparative glass compositions Z1 and Z2 listed in Table 1.

TABLE 2

| Example | A1 | A2 | A3 | A4 | A5 |
|---|---|---|---|---|---|
| Glass composition | C1 | C2 | C3 | C4 | C5 |
| Nucleation hold | 580° C. for 4 hr | 570° C. for 4 hr | 570° C. for 4 hr | 580° C. for 4 hr | 590° C. for 4 hr |
| Crystallization hold | 750° C. for 1 hr | 750° C. for 1 hr | 750° C. for 1 hr | 720° C. for 1 hr | 740° C. for 1 hr |
| Phase assemblage | Lithium | Lithium | Lithium | Lithium | Lithium |
| | disilicate, | disilicate | disilicate, | disilicate, | disilicate, |
| | Petalite | | Petalite, | Petalite, | Cristobalite |
| | | | Cristobalite | Cristobalite | |
| Elastic modulus (GPa) | 98.5 | 103.7 | 104.2 | 103.6 | 103.4 |
| Shear modulus (GPa) | 41.4 | 42.9 | 43.4 | 43.0 | 43.0 |
| Poisson's Ratio | 0.190 | 0.209 | 0.201 | 0.203 | 0.204 |
| K_{Ic} (CN) (MPa · m^{1/2}) | — | 1.24 | 1.22 | 1.13 | 1.23 |
| Haze (0.8 mm) | 0.21 | — | — | — | — |
| Haze (0.6 mm) | — | 0.38 | 0.36 | 0.31 | 0.46 |
| Example | A6 | A7 | A8 | A9 | A10 |
| Glass composition | C6 | C7 | C8 | C9 | C10 |
| Nucleation hold | 590° C. for 4 hr | 590° C. for 4 hr | 590° C. for 4 hr | 580° C. for 4 hr | 580° C. for 4 hr |
| Crystallization hold | 740° C. for 1 hr | 740° C. for 1 hr | 740° C. for 1 hr | 750° C. for 1 hr | 750° C. for 1 hr |
| Phase assemblage | Lithium | Lithium | Lithium | Lithium | Lithium |
| | disilicate, | disilicate | disilicate | disilicate | disilicate |
| | Cristobalite | | | | |
| Elastic modulus (GPa) | 102.8 | 103.8 | 103.4 | 102.3 | 102.3 |
| Shear modulus (GPa) | 42.7 | 43.1 | 42.9 | 42.3 | 42.3 |
| Poisson's Ratio | 0.203 | 0.204 | 0.206 | 0.209 | 0.208 |
| K_{Ic} (CN) (MPa · m^{1/2}) | 1.13 | 1.18 | 1.17 | 1.15 | 1.19 |
| Haze (0.8 mm) | — | — | — | — | — |
| Haze (0.6 mm) | — | — | 0.24 | 0.23 | 0.22 |
| Example | A11 | A12 | A13 | Y1 | Y2 |
| Glass composition | C11 | C12 | C13 | Z1 | Z2 |
| Nucleation hold | 580° C. for 4 hr | 580° C. for 4 hr | 580° C. for 4 hr | 580° C. for 4 hr | 590° C. for 4 hr |
| Crystallization hold | 750° C. for 1 hr | 750° C. for 1 hr | 750° C. for 1 hr | 750° C. for 1 hr | 740° C. for 1 hr |
| Phase assemblage | Lithium | Lithium | Lithium | Lithium | Zircon |
| | disilicate | disilicate | disilicate | Silicate | |
| Elastic modulus (GPa) | 102.8 | 102.5 | 102.7 | 103.3 | 104 |
| Shear modulus (GPa) | 42.5 | 42.4 | 42.5 | 43.0 | 43.0 |
| Poisson's Ratio | 0.208 | 0.209 | 0.209 | 0.19 | 0.19 |
| K_{Ic} (CN) (MPa · m^{1/2}) | 1.17 | 1.19 | 1.19 | 1.13 | 1.16 |
| Haze (0.8 mm) | — | — | — | — | — |
| Haze (0.6 mm) | 0.18 | 0.21 | 0.20 | 0.12 | 0.13 |

As indicated by the example and comparative glass compositions in Table 1 and the example and comparative glass-ceramic articles in Table 2, the precursor glass articles formed from the glass compositions described herein may be subjected to certain heat treatments to form glass-ceramic articles that are transparent, have a lithium disilicate sub-phase, and have relatively high fracture toughness and elastic modulus.

### Example B: Ion Exchange

Table 3 shows the ion exchange conditions including one or two ion exchange baths for achieving example and comparative ion exchanged glass-ceramic articles, and the respective properties of the ion exchanged glass-ceramic articles after each ion exchange bath. Example ion exchanged glass-ceramic articles I1-I13 and comparative ion exchanged glass-ceramic articles X1 and X2 were formed by ion exchanging example glass-ceramic articles A1-A13 and comparative glass-ceramic articles Y1 and Y2 listed in Table 2.

TABLE 3

| Example | I1 | I2 | I3 | I4 | I5 |
|---|---|---|---|---|---|
| Glass-ceramic article | A1 | A2 | A3 | A4 | A5 |

First Ion Exchange Step

| | | | | | |
|---|---|---|---|---|---|
| Salt bath composition | 80% | 60% | 60% | 60% | 60% |
| | KNO₃/20% | KNO₃/40% | KNO₃/40% | KNO₃/40% | KNO₃/40% |
| | NaNO₃ | NaNO₃ + | NaNO₃ + | NaNO₃ + | NaNO₃ + |
| | | 0.12% LiNO₃ | 0.12% LiNO₃ | 0.12% LiNO₃ | 0.12% LiNO₃ |
| Ion exchange schedule | 470° C. for 4 hr | 430° C. for 7 hr | 430° C. for 16 hr | 470° C. for 7 hr | 470° C. for 7 hr |
| Peak surface compressive | 458.0 | — | 289.6 | 382.3 | 362.8 |
| stress (MPa) | | | | | |
| Depth of layer (μm) | 10.9 | <3.5 | — | — | — |
| Maximum central tension | 90.9 | 92.5 | 142.0 | 189.0 | 114.1 |
| (MPa) | | | | | |
| Depth of compression | 154.3 | 106.7 | 114.8 | 113.8 | 114.0 |
| (μm) | | | | | |
| Thickness (mm) | 0.80 | 0.54 | 0.54 | 0.58 | 0.59 |

Second Ion Exchange Step

| Salt bath composition | 100% KNO₃ | 100% KNO₃ | 100% KNO₃ | 100% KNO₃ | 100% KNO₃ |
|---|---|---|---|---|---|
| Ion exchange schedule | 470° C. for 0.5 hr | 470° C. for 1 hr | 470° C. for 1 hr | 470° C. for 1 hr | 470° C. for 1 hr |
| Peak surface compressive | 740.3 | 698.8 | — | 590.7 | 779.5 |
| stress (MPa) | | | | | |
| Depth of layer (μm) | 8.6 | 4.4 | <3.5 | — | 4.1 |
| Maximum central tension | 89.0 | 73.9 | 127.3 | 177.5 | 136.2 |
| (MPa) | | | | | |
| Depth of compression | 160.3 | 118.6 | 120.4 | 125.9 | 129.0 |
| (μm) | | | | | |
| Thickness (mm) | 0.80 | 0.54 | 0.54 | 0.58 | 0.59 |
| Example | I6 | I7 | I8 | I9 | I10 |
| Glass-ceramic article | A6 | A7 | A8 | A9 | A10 |

First Ion Exchange Step

| | | | | | |
|---|---|---|---|---|---|
| Salt bath composition | 60% | 60% | 60% | 60% | 60% |
| | KNO₃/40% | KNO₃/40% | KNO₃/40% | KNO₃/40% | KNO₃/40% |
| | NaNO₃ + | NaNO₃ + | NaNO₃ + | NaNO₃ + | NaNO₃ + |
| | 0.12% LiNO₃ | 0.12% LiNO₃ | 0.12% LiNO₃ | 0.12% LiNO₃ | 0.12% LiNO₃ |
| Ion exchange schedule | 470° C. for 7 hr | 470° C. for 7 hr | 470° C. for 7 hr | 470° C. for 4 hr | 470° C. for 4 hr |
| Peak surface compressive | 358.1 | 368.2 | 396.9 | 263.0 | 231.8 |
| stress (MPa) | | | | | |
| Depth of layer (μm) | — | — | — | — | — |
| Maximum central tension | 157.6 | 170.8 | 190.1 | 122.7 | 106.1 |
| (MPa) | | | | | |
| Depth of compression | 133.9 | 131.7 | 125.5 | 132.0 | 124.2 |
| (μm) | | | | | |
| Thickness (mm) | 0.61 | 0.60 | 0.60 | 0.63 | 0.59 |

Second Ion Exchange Step

| Salt bath composition | 100% KNO₃ | 100% KNO₃ | 100% KNO₃ | 100% KNO₃ | 100% KNO₃ |
|---|---|---|---|---|---|
| Ion exchange schedule | 470° C. for 2 hr | 470° C. for 2 hr | 470° C. for 1 hr | 470° C. for 1 hr | 470° C. for 1 hr |
| Peak surface compressive | 742.1 | 754.3 | 829.1 | 745.7 | 740.1 |
| stress (MPa) | | | | | |
| Depth of layer (μm) | 4.1 | 4.4 | 4.3 | 5.7 | 6.3 |
| Maximum central tension | 138.2 | 139.2 | 158.4 | 109.1 | 87.8 |
| (MPa) | | | | | |
| Depth of compression | 140.1 | 137.3 | 137.8 | 141.4 | 132.5 |
| (μm) | | | | | |
| Thickness (mm) | 0.61 | 0.60 | 0.60 | 0.63 | 0.59 |
| Example | I11 | I12 | I13 | X1 | X2 |
| Glass-ceramic article | A11 | A12 | A13 | Y1 | Y2 |

First Ion Exchange Step

| | | | | | |
|---|---|---|---|---|---|
| Salt bath composition | 60% | 60% | 60% | 60% | 60% |
| | KNO₃/40% | KNO₃/40% | KNO₃/40% | KNO₃/40% | KNO₃/40% |
| | NaNO₃ + | NaNO₃ + | NaNO₃ + | NaNO₃ + | NaNO₃ + |
| | 0.12% LiNO₃ | 0.12% LiNO₃ | 0.12% LiNO₃ | 0.12% LiNO₃ | 0.12% LiNO₃ |
| Ion exchange schedule | 470° C. for 4 hr | 470° C. for 4 hr | 470° C. for 4 hr | 500° C. for 6 hr | 530° C. for 6 hr |
| Peak surface compressive | 297.0 | 247.1 | 336.4 | 272.2 | 391.3 |
| stress (MPa) | | | | | |
| Depth of layer (μm) | — | — | 8.1 | — | — |
| Maximum central tension | 134.9 | 114.8 | 98.4 | 120.1 | 180.4 |
| (MPa) | | | | | |
| Depth of compression | 117.4 | 128.9 | 111.7 | 120.4 | 129.4 |
| (μm) | | | | | |
| Thickness (mm) | 0.57 | 0.62 | 0.56 | 0.60 | 0.60 |

Second Ion Exchange Step

| | | | | | |
|---|---|---|---|---|---|
| Salt bath composition | 100% KNO₃ | 100% KNO₃ | 100% KNO₃ | — | — |
| Ion exchange schedule | 470° C. for 1 hr | 470° C. for 1 hr | 470° C. for 1 hr | — | — |
| Peak surface compressive | 774.9 | 758.2 | 756.2 | — | — |
| stress (MPa) | | | | | |
| Depth of layer (μm) | 4.4 | 6.0 | 6.2 | — | — |
| Maximum central tension | 115.4 | 96.9 | 81.9 | — | — |
| (MPa) | | | | | |
| Depth of compression | 128.9 | 141.8 | 122.5 | — | — |
| (μm) | | | | | |
| Thickness (mm) | 0.57 | 0.62 | 0.56 | — | — |

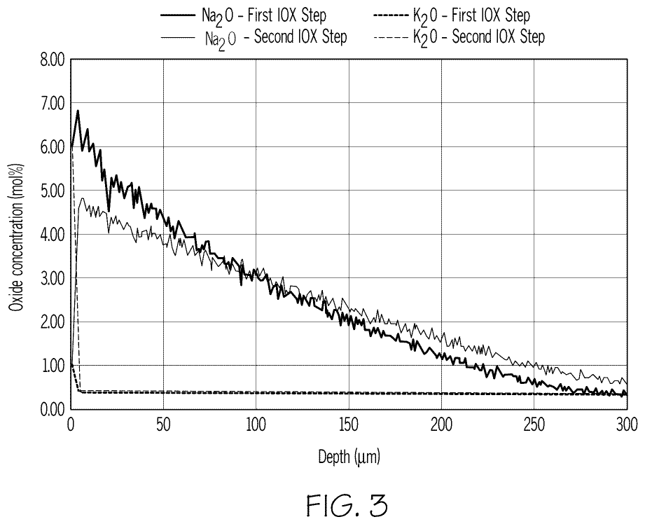

Referring now to FIG. 3, the first ion exchange step to form ion exchanged glass-ceramic article 18 as listed in Table 3 resulted in a Na₂O surface concentration of about 6 mol % and a K₂O surface concentration of about 1 mol %. The relatively higher Na₂O surface concentration was related to a relatively greater amount of Li ions present in the glass-ceramic article being replaced with the Na ions present in the ion exchange bath, which resulted in a relatively higher maximum central tension. The second ion exchange step to form ion exchanged glass-ceramic article 18 as listed in Table 3 resulted in a K₂O surface concentration of about 6 mol % to a depth of layer about 6 μm. The higher K₂O surface concentration was related to a relatively greater amount of Na ions present at the surface of the glass-ceramic article after the first ion exchange step being replaced with the K ions present in the ion exchange bath, which resulted in a relatively higher peak surface compressive stress.

As indicated by Table 3 and FIG. 3, the glass-ceramic articles described herein may be subjected to certain ion exchange conditions to achieve a relatively higher peak surface compressive stress.

### Example C: Scratch Data

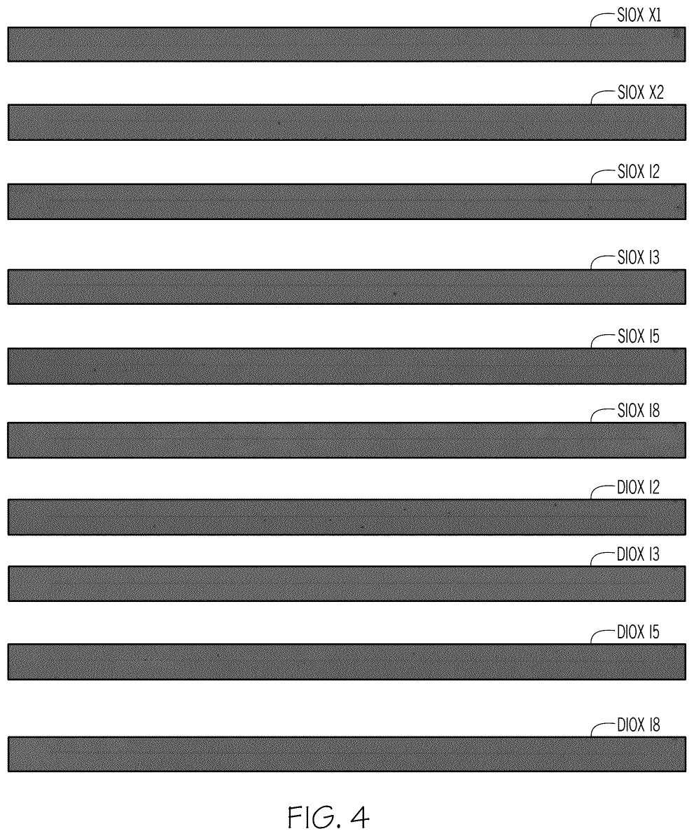

Scratch testing was performed on samples using an Anton Paar MicroCombi Unit having a 10 μm/90 degree angle conospherical tip and a scratch speed of 24 mm/min to form a 10 mm scratch. Referring now to FIG. 4, single ion exchanged (SIOX) (i.e., only subjected to first ion exchange step) and double ion exchanged (DIOX) (i.e., subjected to both first and second ion exchange steps) glass-ceramic articles I2, I3, I5, and I8 and SIOX comparative glass-ceramic articles X1 and X2 were subjected to scratch testing using a constant load of 0.25 N. As shown, regardless of peak surface compressive stress, all articles tested exhibited similar microductile behavior and visibility.

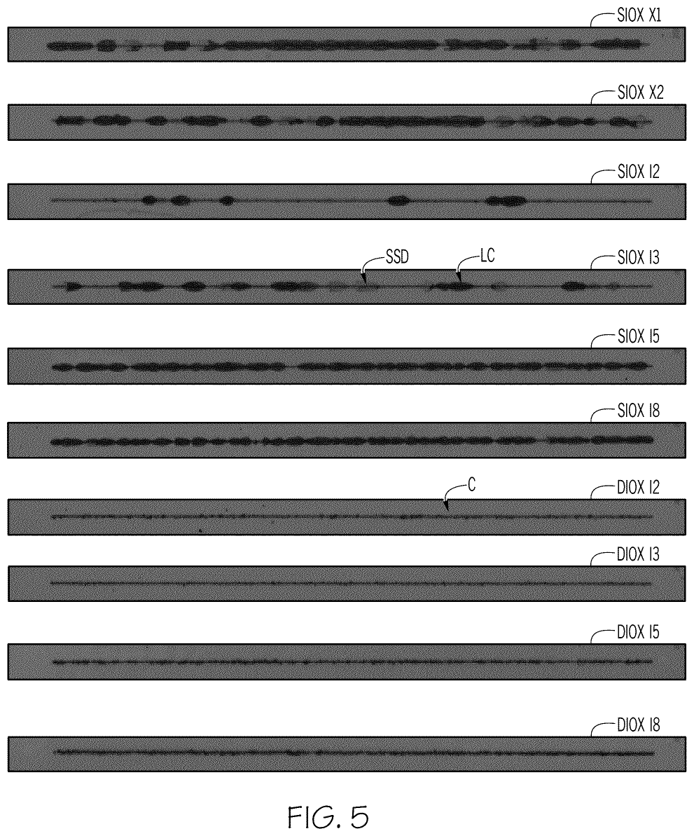

Referring now to FIG. 5, SIOX and DIOX glass-ceramic articles I2, I3, I5, and I8 and SIOX comparative glass-ceramic articles X1 and X2 were subjected to scratch testing using a constant load of 0.5 N. As shown, SIOX glass-ceramic articles I2, I3, I8 and SIOX comparative glass-ceramic articles X1 and X2, each having a peak surface compressive stress less than 500 MPa, exhibited subsurface damage and lateral cracking visible to a user. Subsurface damage SSD showed as light gray spots and lateral cracking LC shows as black spots as shown on SIOX glass-ceramic article 13. DIOX glass-ceramic articles I2, I3, I5, and I8, each having a peak surface compress stress greater than or equal to 500 MPa, had reduced to no subsurface damage and lateral cracking and improved visibility as compared to the SIOX counterparts and comparative SIOX glass-ceramic articles. DIOX glass-ceramic articles I2, I3, I5, and I8 merely exhibited crushing as shown by C on DIOX glass—ceramic article I2.

Referring now to Table 4, the widest width, mean width, and standard deviation of lateral cracking of SIOX and DIOX glass-ceramic articles I2, I3, I5, and I8 and SIOX comparative glass-ceramic articles X1 and X2 subjected to scratch testing using a constant load of 0.5 N is shown. SIOX glass-ceramic articles I2, I3, I8 and SIOX comparative glass-ceramic articles X1 and X2, each having a peak surface compressive stress less than 500 MPa, exhibited a widest width of lateral cracking greater than 125 μm and a mean width of lateral cracking greater than 100 μm. DIOX glass-ceramic articles I2, I3, I5, and I8, each having a peak surface compressive stress greater than or equal to 500 MPa, exhibited a widest width of lateral cracking less than 125 μm and a mean width of lateral cracking less than 100 μm.

As exemplified by FIG. 5 and Table 4, the glass-ceramic articles described herein may be subjected to certain ion exchange conditions to minimize subsurface damage upon scratching, thereby preventing the formation of lateral crack systems and ultimately resulting in lower scratch visibility for the user. While not wishing to be bound by theory, it is believed that the minimized subsurface damage upon scratching is a result of a relatively high peak compressive stress achieved during ion exchange.

TABLE 4

| | | | Standard |
|---|---|---|---|
| | Widest width | Mean width | deviation |
| | (μm) | (μm) | (μm) |
| SIOX X1 | 228.96 | 158.09 | 61.16 |
| SIOX X2 | 220.42 | 159.84 | 60.03 |
| SIOX I2 | 181.43 | 126.33 | 63.21 |
| SIOX I3 | 180.60 | 139.89 | 59.78 |
| SIOX I5 | 169.34 | 126.57 | 43.17 |
| SIOX I8 | 155.11 | 129.77 | 36.04 |
| DIOX I2 | 91.66 | 64.77 | 21.42 |
| DIOX I3 | 69.99 | 57.59 | 19.57 |
| DIOX I5 | 108.94 | 75.20 | 28.66 |
| DIOX I8 | 94.34 | 73.65 | 23.24 |

### Example D: Mechanical Performance

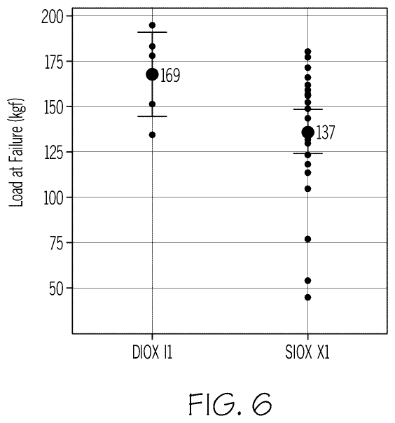

Referring now to FIG. 6, DIOX example glass-ceramic article I1 (i.e., subjected to first and second ion exchange steps) and SIOX comparative glass-ceramic article X1 were subjected to a ring-on-ring test in accordance with ASTM C1499-19 with a specimen quantity of 6, a contact radius of 1.6 mm, a cross head speed of 1.2 mm/min, a load ring diameter of 0.5 inch, and a support ring of 1 inch. Ion exchanged glass-ceramic article I1 had a higher failure load than SIOX comparative glass-ceramic article X1. As indicated by FIG. 6, the glass-ceramic articles described herein may be ion exchanged to achieve improved mechanical performance as compared to comparative ion exchanged glass-ceramic articles.

It will be apparent to those skilled in the art that various modifications and variations may be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

What is claimed is:

1. A glass-ceramic article comprising:
a crystalline phase;
a residual glass phase;
greater than or equal to 55 mol % and less than or equal to 80 mol % SiO₂;
greater than or equal to 1 mol % and less than or equal to 8 mol % Al₂O₃;
greater than or equal to 13 mol % and less than or equal to 35 mol % Li₂O;
greater than or equal to 0.05 mol % and less than or equal to 5 mol % Na₂O;
greater than or equal to 0.05 mol % and less than or equal to 3 mol % K₂O;
greater than or equal to 0.2 mol % and less than or equal to 2 mol % P₂O₅; and
greater than or equal to 1.5 mol % and less than or equal to 10 mol % ZrO₂, wherein the crystalline phase comprises a lithium disilicate sub-phase.

2. The glass-ceramic article of claim 1, wherein the lithium disilicate sub-phase is present in a greater amount, based on a total weight of the crystalline phase, than any other sub-phase in the crystalline phase.

3. The glass-ceramic article of claim 1, wherein the glass-ceramic article has a surface concentration of K₂O greater than or equal to 1 mol %.

4. The glass-ceramic article of claim 1, wherein the glass-ceramic article has a haze less than or equal to 0.5, as measured at an article thickness of 0.6 mm.

5. The glass-ceramic article of claim 1, wherein the glass-ceramic article has a widest width of lateral cracking less than or equal to 125 lam when subjected to scratch testing to initiate a scratch with a 10 μm/90 degree angle conospherical tip, a scratch speed of 24 mm/min, and a constant load of 0.5 N.

6. The glass-ceramic article of claim 1, wherein the glass-ceramic article has a mean width of lateral cracking less than or equal to 100 lam when subjected to scratch testing to initiate a scratch with a 10 μm/90 degree angle conospherical tip, a scratch speed of 24 mm/min, and a constant load of 0.5 N.

7. The glass-ceramic article of claim 1, wherein Na₂O+K₂O is greater than or equal to 0.1 mol % to less than or equal to 8 mol %.

8. The glass-ceramic article of claim 1, wherein the crystalline phase of the glass-ceramic article comprises a lithium metasilicate sub-phase, a lithium phosphate sub-phase, a petalite sub-phase, a cristobalite sub-phase, or combinations thereof.

9. The glass-ceramic article of claim 1, wherein the glass-ceramic article has a peak surface compressive stress greater than or equal to 500 MPa.

10. The glass-ceramic article of claim 1, wherein the glass-ceramic article has a depth of layer greater than or equal to 2 μm, a maximum central tension greater than or equal to 65 MPa, a thickness “t,” and a depth of compression greater than or equal to 0.05t.

11. The glass-ceramic article of claim 1, wherein the glass-ceramic article has an elastic modulus greater than or equal to 95 GPa.

12. The glass-ceramic article of claim 1, wherein the glass-ceramic article has a K_{Ic} fracture toughness as measured by a chevron notched short bar method is greater than or equal to 1.1 MPa·m^{1/2}.

13. A glass composition comprising:
greater than or equal to 55 mol % and less than or equal to 80 mol % SiO₂;
greater than or equal to 1 mol % and less than or equal to 8 mol % Al₂O₃;
greater than or equal to 13 mol % and less than or equal to 35 mol % Li₂O;
greater than or equal to 0.10 mol % and less than or equal to 5 mol % Na₂O;
greater than or equal to 0.10 mol % and less than or equal to 3 mol % K₂O;
greater than or equal to 0.2 mol % and less than or equal to 2 mol % P₂O₅; and
greater than or equal to 1.5 mol % and less than or equal to 10 mol % ZrO₂.

14. The glass composition of claim 13, wherein Na₂O/(Na₂O+K₂O) is greater than or equal to 0.02 and less than or equal to 0.99.

15. The glass composition of claim 13, wherein Na₂O+K₂O is greater than or equal to 0.2 mol % to less than or equal to 8 mol %.

16. A method of forming a glass-ceramic article, the method comprising:
heating a precursor glass article in an oven at a rate greater than or equal to 1° C./min and less than or equal to 10° C./min to a nucleation temperature, wherein the precursor glass article comprises a glass composition comprising:
greater than or equal to 55 mol % and less than or equal to 80 mol % SiO₂;
greater than or equal to 1 mol % and less than or equal to 8 mol % Al₂O₃;
greater than or equal to 13 mol % and less than or equal to 35 mol % Li₂O;
greater than or equal to 0.10 mol % and less than or equal to 5 mol % Na₂O;
greater than or equal to 0.10 mol % and less than or equal to 3 mol % K₂O;
greater than or equal to 0.2 mol % and less than or equal to 2 mol % P₂O₅; and
greater than or equal to 1.5 mol % and less than or equal to 10 mol % ZrO₂;
maintaining the precursor glass article at the nucleation temperature in the oven for a nucleation time greater than or equal to 0.1 hour and less than or equal to 8 hours to produce a nucleated crystallizable glass article;
heating the nucleated crystallizable glass article in the oven at a rate greater than or equal to 1° C./min and less than or equal to 10° C./min to a crystallization temperature;
maintaining the nucleated crystallizable glass article at the crystallization temperature in the oven for a crystallization time greater than or equal to 0.25 hour and less than or equal to 4 hours to produce the glass-ceramic article, wherein the glass-ceramic article comprises a crystalline phase and a residual glass phase; and
cooling the glass-ceramic article to room temperature.

17. The method of claim 16, wherein the crystalline phase comprises a lithium disilicate sub-phase, the lithium disilicate sub-phase being present in a greater amount, based on a total weight of the crystalline phase, than any other sub-phase in the crystalline phase.

18. The method of claim 16, further comprising strengthening the glass-ceramic article in a first ion exchange bath at a first bath temperature greater than or equal to 350° C. to less than or equal to 550° C. for an ion exchange time period greater than or equal to 2 hours to less than or equal to 12 hours to form an ion exchanged glass-ceramic article.

19. The method of claim 18, further comprising strengthening the glass-ceramic article in a second ion exchange bath at a second bath temperature greater than or equal to 350° C. to less than or equal to 550° C. for a second ion exchange time period greater than or equal to 0.25 hour to less than or equal to 4 hours.

20. The method of claim 18, wherein the ion exchanged glass-ceramic article has a peak surface compressive stress greater than or equal to 500 MPa.
